(19) United States
(12) Patent Application Publication
(10) Pub. No.: US 2012/0057219 A1
(43) Pub. Date: Mar. 8, 2012

(54) LASER LIGHT SOURCE APPARATUS

(75) Inventors: Kohei SUYAMA, Fukuoka (JP); Hirohiko Oowaki, Fukuoka (JP); Tomohiro MATSUO, Fukuoka (JP); Yuichi HATASE, Fukuoka (JP); Kenji NAKAYAMA, Kumamoto (JP); Takafumi HAMANO, Fukuoka (JP)

(73) Assignee: PANASONIC CORPORATION, Osaka (JP)

(21) Appl. No.: 13/223,720

(22) Filed: Sep. 1, 2011

(30) Foreign Application Priority Data
Sep. 7, 2010 (JP) 2010-199721
Sep. 7, 2010 (JP) 2010-199723
Sep. 10, 2010 (JP) 2010-203043

(51) Int. Cl. G02F 1/37

(52) U.S. Cl. 359/328

(57) ABSTRACT

In a laser light source apparatus using a wavelength converting device (35), the position and angle of the wavelength converting device are allowed to be varied so as to maximize the laser output. The angular adjustment of the wavelength converting device is simplified by accurately positioning the wavelength converting device. A holder (57) for retaining the wavelength converting device may be supported by a support portion (56) formed in a base (38) so as to be moveable in the depthwise direction of the poled inverted domain regions and tiltable with respect to the optical path. Preferably, the holder may be rotatable around an axial line substantially perpendicular to the optical axial line. In particular, the wavelength converting device may be fixedly attached to the holder so as to bring an exit surface (35b) of the wavelength converting device in close contact with a mounting reference surface (841) by using a bonding agent applied to a top surface (35e) and a bottom surface (35f) of the wavelength converting device adjacent to the exit surface, and a bottom surface (207) of a recess (891) formed in the holder adjacent to and in parallel with the mounting reference surface.

### TECHNICAL FIELD

The present invention relates to a laser light source apparatus using a semiconductor laser, and in particular to a laser light source apparatus suitable for use in image display systems.

### BACKGROUND OF THE INVENTION

In recent years, there is a growing interest in the use of the semiconductor laser as the light source of image display systems. The semiconductor laser has various advantages over the mercury lamp which is commonly used as the light source for conventional image display systems, such as a better color reproduction, the capability to turn on and off instantaneously, a longer service life, a higher efficiency (or a lower power consumption) and the amenability to compact design.

An example of image display system using a semiconductor laser is disclosed in JP 2007-316393A. Three lasers beams of red, blue and green colors generated by three laser units consisting of semiconductor lasers are projected onto a display area of a reflective LCD panel, and the light beams of the different colors imaged and reflected by the reflective LCD panel are projected onto an external screen.

As no semiconductor laser that can directly generate a green laser beam at a high power output is available, it is known to use a laser beam obtained from a semiconductor laser for exciting a laser medium to generate an infrared laser beam, and convert the infrared laser beam into a green laser beam by using a nonlinear optical process (wavelength converting device) as disclosed in JP 2008-16833A.

In a green laser light source apparatus using a wavelength converting device, the laser output is affected by the position and angle of the wavelength converting device with respect to the optical axial line of the laser beam, it is important to place the wavelength converting device at a position and angle that maximize the laser output. However, as some error is inevitable in the manufacturing precision and the assembling precision of the wavelength converting device, the laser output may vary from one device to another. Therefore, it is desirable to be able to adjust the position and angle of the wavelength converting device with respect to the optical axial line of the laser beam.

It is conceivable to configure the green laser light source apparatus such that the position and angle of the wavelength converting device may be adjusted while monitoring the laser output even after the apparatus is fully assembled. To achieve this, a highly complex adjustment mechanism would be required, and the manufacturing cost may be unacceptably increased to allow the position and angle of the wavelength converting device to be varied in all possible directions. On the other hand, if the wavelength converting device is highly accurately assembled, then it will suffice to allow the angular adjustment to be made only in one or two directions, and the resulting simplification of the adjust mechanism allows the manufacturing cost to be reduced.

### BRIEF SUMMARY OF THE INVENTION

The present invention was made in view of such problems of the prior art and based on the aforementioned recognition by the inventors, and has a primary object to provide a laser light source apparatus using a wavelength converting device that allows the position and angle of the wavelength converting device to be varied so as to maximize the laser output.

A second object of the present invention is to provide a laser light source apparatus using a wavelength converting device that can simplify the angular adjustment of the wavelength converting device by accurately positioning the wavelength converting device.

To achieve the primary object, the present invention provides a laser light source apparatus for generating a half wavelength laser beam from a base wavelength laser beam, comprising: a laser device for emitting a base wavelength laser beam; an optical system for causing a resonation of the base wavelength laser beam; a wavelength converting device including a plurality of periodically formed poled inverted domain regions, each poled inverted domain region being wedge shaped and progressively narrower in a depthwise direction thereof for converting at least part of the base wavelength laser beam into a half wavelength laser beam; a holder for retaining the wavelength converting device on an optical path of the base wavelength laser beam in the optical system; and a base provided with a support portion for supporting the holder; the holder being supported by the support portion so as to be moveable in the depthwise direction of the poled inverted domain regions and tiltable with respect to the optical path.

Preferably, the holder is rotatable around an axial line substantially perpendicular to both the optical axial line and the depthwise direction of the poled inverted domain regions.

Thereby, the position of the wavelength converting device in the depthwise direction of the poled inverted domain regions, and the angular position of the wavelength converting device with respect to the optical axial line can be optimized, and the laser output can be maximized.

According to another aspect of the present invention, the present invention provides a laser light source apparatus for generating a half wavelength laser beam from a base wavelength laser beam, comprising: a laser device for emitting a base wavelength laser beam; an optical system for causing a resonation of the base wavelength laser beam; a wavelength converting device for converting at least part of the base wavelength laser beam amplified by the resonation into a half wavelength laser beam; a holder for retaining an optical element included in the wavelength converting device; and a base provided with a support portion for supporting the holder; wherein the optical element includes an incident surface and an exit surface, and the holder is provided with a mounting reference surface with which one of the incident surface and exit surface is brought into contact for positioning the optical element, and wherein the optical element is fixedly attached to the holder by using a bonding agent applied to both a surface of the optical element adjacent to the one of the incident surface and exit surface and a surface of the holder adjacent to an parallel to the mounting reference surface.

Thereby, the contracting force produced by the curing of the bonding agent urges the one of the incident surface and exit surface of the optical element onto the mounting reference surface, and the two surfaces can be kept in close contact with each other. Therefore, the mounting precision of the optical element with respect to the holder can be ensured, and this simplifies the angular adjustment of the optical element.

### BRIEF DESCRIPTION OF THE DRAWINGS

Now the present invention is described in the following with reference to the appended drawings, in which:

FIG. 1 is a schematic diagram showing an image display system 1 incorporated with a green laser light source apparatus 2 embodying the present invention;

FIG. 2 is a diagram showing the optical structure of the green laser light source apparatus 2;

FIG. 3 is a perspective view of the interior of the green laser light source apparatus 2;

FIG. 4 is a perspective view of a wavelength converting device 35 used in the green laser light source apparatus 2;

FIG. 5 is an exploded perspective view of a wavelength converting device holder 57 for the wavelength converting device 35;

FIG. 6 is a mounting structure for mounting the wavelength converting device holder 57 on the holder support portion 59 of the base 38;

FIG. 7 is an enlarged schematic side view of the projection 91 of the wavelength converting device holder 57 engaging the recess 92 of the holder support portion 59;

FIG. 8 is a graph showing the relationship between the wavelength conversion efficiency η and the inclination angle θ of the wavelength converting device 35;

FIG. 9A is a plan view showing the mode of adjusting the lateral position of the wavelength converting device holder 57;

FIG. 9B is a plan view showing the mode of adjusting the lateral angle of the wavelength converting device holder 57;

FIG. 9C is a side view showing of the mode of adjusting the vertical angle of the wavelength converting device holder 57;

FIG. 10 is a perspective view showing how the position and angle of the wavelength converting device 35 are adjusted;

FIG. 11 is a perspective view showing a laptop type information processing apparatus 111 incorporated with the image display system 1 of the present invention;

FIG. 12 is a perspective view partly in section of the green laser source apparatus 2 given as a second embodiment of the present invention;

FIG. 13 is a sectional side view of the green laser source apparatus 2 shown in FIG. 12;

FIG. 14 is an exploded perspective view of a wavelength converting device holder 581 of the green laser source apparatus 2;

FIG. 15 is a fragmentary exploded perspective view of the green laser source apparatus 2;

FIG. 16A is a perspective view showing the mode of adjusting the lateral position of the wavelength converting device holder 581 by using the adjustment jigs 301 to 304;

FIG. 16B is a perspective view showing the mode of adjusting the lateral angle of the wavelength converting device holder 581 by using the adjustment jigs 301 to 304;

FIG. 17 is a plan view showing the mode of adjusting the position and angle of the wavelength converting device holder 581 by using the adjustment jigs 301 to 304;

FIG. 18 is a perspective view showing how the position and angle of the wavelength converting device 35 are adjusted;

FIG. 19 is a sectional side view showing a modified embodiment of the wavelength converting device holder;

FIG. 20 is a sectional side view showing another modified embodiment of the wavelength converting device holder;

FIG. 21 is a schematic diagram illustrating the mode of fabricating the wavelength converting device 35;

FIG. 22 is a perspective view showing the structure for securing the wavelength converting device 35 to the wavelength converting device holder 581; and

FIG. 23 is a sectional side view showing how the bonding agent 206 applies an urging force to the wavelength converting device 35.

### DETAILED DESCRIPTION OF THE PREFERRED EMBODIMENT(S)

According to a broad aspect of the present invention, the present invention provides a laser light source apparatus for generating a half wavelength laser beam from a base wavelength laser beam, comprising: a laser device for emitting a base wavelength laser beam; an optical system for causing a resonation of the base wavelength laser beam; a wavelength converting device including a plurality of periodically formed poled inverted domain regions, each poled inverted domain region being wedge shaped and progressively narrower in a depthwise direction thereof for converting at least part of the base wavelength laser beam into a half wavelength laser beam; a holder for retaining the wavelength converting device on an optical path of the base wavelength laser beam in the optical system; and a base provided with a support portion for supporting the holder; the holder being supported by the support portion so as to be moveable in the depthwise direction of the poled inverted domain regions and tiltable with respect to the optical path.

Thereby, the position of the wavelength converting device in the depthwise direction of the poled inverted domain regions, and the angular position of the wavelength converting device with respect to the optical axial line can be optimized, and the laser output can be maximized.

The wavelength converting device may include a plurality of periodically formed poled inverted domain regions, each poled inverted domain region being wedge shaped and progressively narrower in a depthwise direction thereof for converting at least part of the base wavelength laser beam into a half wavelength laser beam. Therefore, by moving the wavelength converting device in the depthwise direction of the poled inverted domain regions, the length of the part of the optical path consisting of the poled inverted domain regions changes, and the wavelength conversion efficiency changes in a corresponding manner. The position of the wavelength converting device along this direction can be adjusted so as to maximize the wavelength conversion efficiency.

In particular, by tilting the wavelength converting device with respect to the optical axial line, the optical path of the laser beam may be shifted at the incident surface and exit surface of the wavelength converting device by refraction so that the reduction in the laser output owing to the interference of laser beams can be avoided. The tilting angle of the wavelength converting device with respect to the optical axial line may be adjusted so as to maximize the laser output.

According to a certain aspect of the present invention, one of the holder and the support portion is provided with a spherical projection, and the other of the holder and the support portion is provided with a recess elongated in the depthwise direction of the poled inverted domain regions to receive the spherical projection.

Thereby, the holder may be laterally moved and tilted with respect the support portion by using a highly simple structure.

According to another aspect of the present invention, an optical path hole is formed in each of the spherical projection and the recess for conducting the laser beam.

According to this arrangement, because the projection and recess engage each other exactly on the optical axial line, the tilting of the holder does not cause any significant changes in the position of the wavelength converting device along the optical axial line.

According to yet another aspect of the present invention, the holder and the support portion are urged against each other by a spring.

Thereby, the holder is prevented from dislodging or falling off from the support portion during the positional and angular adjustment of the wavelength converting device, and this simplifies the adjustment work. The spring may be used for a temporary attachment of the holder to the support portion during the adjustment work, and the two parts may be permanently attached to each other by using a bonding agent once the adjustment work is finished.

According to yet another aspect of the present invention, the laser device comprises a semiconductor laser for generating an excitation laser beam, and a laser medium for generating the base wavelength laser beam by being excited by the excitation laser beam, the semiconductor laser, the laser medium and the wavelength converting device being integrally supported by the base.

Thereby, a green laser beam of a high power can be generated. In this case, after the semiconductor laser is fixedly attached to the base, the positional adjustment of the semiconductor laser, the laser medium and the wavelength converting device may be made with respect to the optical axial line of the laser beam emitted from a laser chip.

According to yet another aspect of the present invention, the holder is supported by the support portion so as to be rotatable around an axial line substantially perpendicular to the optical axial line.

Thereby, the position of the wavelength converting device in the depthwise direction of the poled inverted domain regions, and the angular position of the wavelength converting device with respect to the optical axial line can be optimized, and the laser output can be maximized.

The wavelength converting device may include a plurality of periodically formed poled inverted domain regions, each poled inverted domain region being wedge shaped and progressively narrower in a depthwise direction thereof for converting at least part of the base wavelength laser beam into a half wavelength laser beam. Therefore, by moving the wavelength converting device in the depthwise direction of the poled inverted domain regions, the length of the part of the optical path consisting of the poled inverted domain regions changes, and the wavelength conversion efficiency changes in a corresponding manner. The position of the wavelength converting device along this direction can be adjusted so as to maximize the wavelength conversion efficiency.

In particular, by tilting the wavelength converting device with respect to the optical axial line, the optical path of the laser beam may be shifted at the incident surface and exit surface of the wavelength converting device by refraction so that the reduction in the laser output owing to the interference of laser beams can be avoided. The tilting angle of the wavelength converting device with respect to the optical axial line may be adjusted so as to maximize the laser output.

According to yet another aspect of the present invention, the holder is rotatable around an axial line substantially perpendicular to both the optical axial line and the depthwise direction of the poled inverted domain regions.

Thereby, the inclination angle of the wavelength converting device around an axial line substantially perpendicular to both the optical axial line and the depthwise direction of the poled inverted domain regions can be adjusted.

The inclination angle of the wavelength converting device around an axial line parallel to the depthwise direction of the poled inverted domain regions is also important, but by assembling the wavelength converting device at a high precision such that the inclination angle in this direction is close to zero, the need of the adjustment of the inclination angle of the wavelength converting device in this direction may be eliminated. The reduction in the laser output due to the interference of laser beams can be accomplished by adjusting the inclination angle of the wavelength converting device around an axial line substantially perpendicular to both the optical axial line and the depthwise direction of the poled inverted domain regions.

According to yet another aspect of the present invention, the base is provided with a first reference surface defining a plane perpendicular to the optical axial line, and the holder is provided with a shaft portion in rolling engagement with the first reference surface.

According to this arrangement, the first reference surface determines the position of the holder along the optical axial line, and the position of the wavelength converting device along the depthwise direction of the poled inverted domain regions and the inclination angle thereof with respect to the optical axial line can be adjusted without changing the position of the wavelength converting device along the optical axial line.

According to yet another aspect of the present invention, the base is provided with a second reference surface defining a plane perpendicular to the first reference surface and in parallel with the optical axial line, and the holder is provided with a leg portion in sliding engagement with the second reference surface.

Thereby, the shaft portion is prevented from tilting with respect to a designed direction substantially perpendicular to both the optical axial line and the depthwise direction of the poled inverted domain regions.

According to yet another aspect of the present invention, the apparatus further comprises a spring for urging the leg portion against the second reference surface.

According to this arrangement, by pushing the wavelength converting device holder from sideways by using suitable jigs, the wavelength converting device holder may be displaced laterally without tilting the shaft portion from the designed direction. The spring may be used for a temporary attachment of the holder to the support portion during the adjustment work, and the two parts may be permanently attached to each other by using a bonding agent once the adjustment work is finished.

According to yet another aspect of the present invention, the laser device comprises a semiconductor laser for generating an excitation laser beam, and a laser medium for generating the base wavelength laser beam by being excited by the excitation laser beam, the semiconductor laser, the laser medium and the wavelength converting device being integrally supported by the base.

Thereby, a green laser beam of a high power can be generated. In this case, after the semiconductor laser is fixedly attached to the base, the positional adjustment of the semiconductor laser, the laser medium and the wavelength converting device may be made with respect to the optical axial line of the laser beam emitted from a laser chip.

According to yet another aspect of the present invention, the present invention provides a laser light source apparatus for generating a half wavelength laser beam from a base wavelength laser beam, comprising: a laser device for emitting a base wavelength laser beam; an optical system for causing a resonation of the base wavelength laser beam; a wavelength converting device for converting at least part of the base wavelength laser beam amplified by the resonation into a half wavelength laser beam; a holder for retaining an optical element included in the wavelength converting device; and a base provided with a support portion for supporting the holder; wherein the optical element includes an incident surface and an exit surface, and the holder is provided with a mounting reference surface with which one of the incident surface and exit surface is brought into contact for positioning the optical element, and wherein the optical element is fixedly attached to the holder by using a bonding agent applied to both a surface of the optical element adjacent to the one of the incident surface and exit surface and a surface of the holder adjacent to an parallel to the mounting reference surface.

Thereby, the contracting force produced by the curing of the bonding agent urges the one of the incident surface and exit surface of the optical element onto the mounting reference surface, and the two surfaces can be kept in close contact with each other. Therefore, the mounting precision of the optical element with respect to the holder can be ensured, and this simplifies the angular adjustment of the optical element.

According to yet another aspect of the present invention, the optical element comprises a wavelength converting device including a plurality of periodically formed poled inverted domain regions, each poled inverted domain region being wedge shaped and progressively narrower in a depthwise direction thereof for converting at least part of the base wavelength laser beam into a half wavelength laser beam.

Thereby, the inclination angle of the wavelength converting device with respect to the optical axial line may be optimized, and the laser output can be maximized.

In particular, by tilting the wavelength converting device with respect to the optical axial line, the optical path of the laser beam may be shifted at the incident surface and exit surface of the wavelength converting device by refraction so that the reduction in the laser output owing to the interference of laser beams can be avoided. The tilting angle of the wavelength converting device with respect to the optical axial line may be adjusted so as to maximize the laser output.

The inclination angle of the incident surface and exit surface of the wavelength converting device with respect to a plane perpendicular to the optical axial line is important. By providing the wavelength converting device so as to be rotatable around a pair of axial lines which are perpendicular to each other and perpendicular to the optical axial line, the manufacturing error and assembling error can be eliminated, and the inclination angle of the incident surface and exit surface of the wavelength converting device with respect to the optical axial line can be optimized. However, by assembling the wavelength converting device at a high precision such that the inclination angle around one of the axial lines is close to zero, the need of the adjustment of the inclination angle of the wavelength converting device in this direction may be eliminated.

According to yet another aspect of the present invention, the bonding agent is applied to each of a pair of opposite surfaces of the optical element adjacent to the one of the incident surface and exit surface, and a surface of the holder adjacent to and parallel to the mounting reference surface. In other words, the bonding agent is applied to a pair of mutually opposing surfaces of the optical element.

Curing of the bonding agent creates a contracting force, and the contracting forces of the bonding agent applied to the two opposing surfaces of the optical element balance with each other. Therefore, mounting precision of the wavelength converting device can be improved.

By combining different aspects of the present invention, the bonding agent may be applied to the two surfaces of the wavelength converting device opposing each other along the rotational center line of the wavelength converting device. Thereby, the mounting angle of the wavelength converting device around an axial line perpendicular to the rotational center line can be ensured at a high precision, and the need of the adjustment of the inclination angle of the wavelength converting device in this direction may be eliminated.

According to yet another aspect of the present invention, the one of the incident surface and exit surface has an elongated rectangular shape, and the holder is rotatable around an axial line substantially perpendicular to both the optical axial line and the depthwise direction of the poled inverted domain regions, the optical element being placed against the mounting reference surface with one of long sides of the one of the incident surface and exit surface extending in parallel with the rotational axial line of the holder.

Thereby, the tilting of the wavelength converting device around one of the short sides of the contact surface can be avoided so that the mounting angular precision around an axial line perpendicular to the rotational center line can be ensured at a high precision, and the need of the adjustment of the inclination angle of the wavelength converting device in this direction may be eliminated.

In this case also, the laser device may comprise a semiconductor laser for generating an excitation laser beam, and a laser medium for generating the base wavelength laser beam by being excited by the excitation laser beam, the semiconductor laser, the laser medium and the wavelength converting device being integrally supported by the base.

Thereby, a green laser beam of a high power can be generated. In this case, after the semiconductor laser is fixedly attached to the base, the positional adjustment of the semiconductor laser, the laser medium and the wavelength converting device may be made with respect to the optical axial line of the laser beam emitted from a laser chip.

### First Embodiment

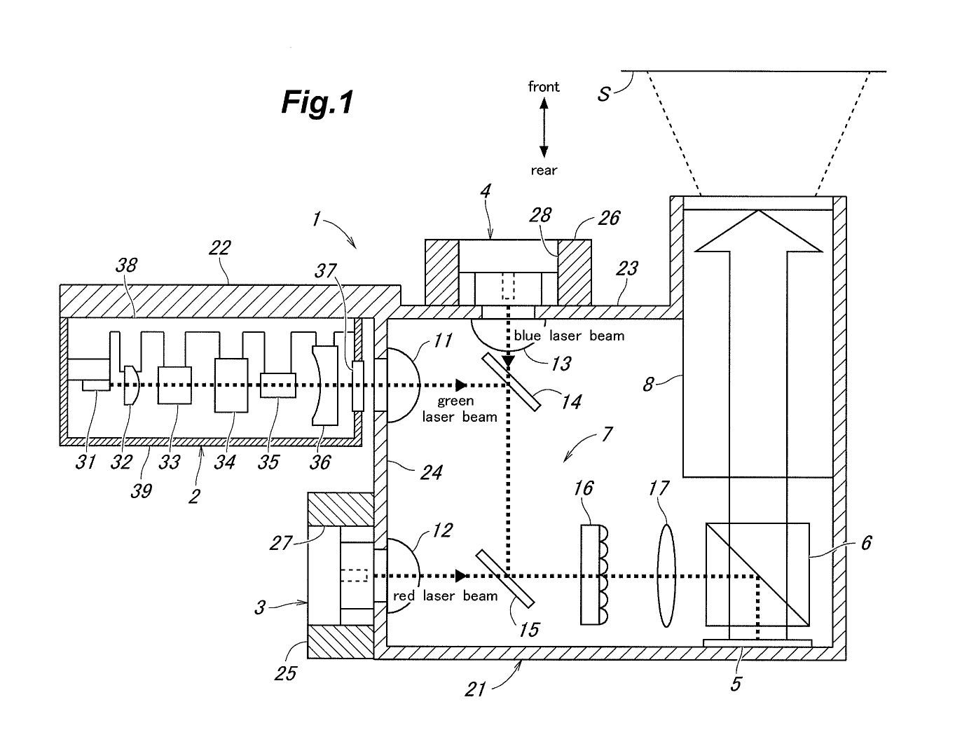

A first embodiment of the present invention is described in the following with reference to FIGS. 1 to 10.

FIG. 1 is a schematic diagram showing an image display system incorporated with a green laser light source apparatus (green laser light source unit 2) embodying the present invention. The image display system 1 is configured to project a given image onto a screen S, and comprises a green laser light source unit 2 for emitting a green laser beam, a red laser light source unit 3 for emitting a red laser beam, a blue laser light source unit 4 for emitting a blue laser beam, a spatial light modulator 5 of a reflective LCD type for forming the required image by spatially modulating the laser beams from the green, red and blue laser light source units 2 to 4 according to the given video signal, a polarizing beam splitter 6 that reflects the laser beams emitted from the green, red and blue laser light source units 2 to 4 onto the spatial light modulator 5 and transmits the modulated laser beam emitted from the spatial light modulator 5, a relay optical system 7 for directing the laser beams emitted from the green, red and blue laser light source units 2 to 4 to the beam splitter 6, and a projection optical system 8 for projecting the modulated laser beam transmitted through the beam splitter 6 onto the screen S.

The image display system 1 is configured such that the laser beam emitted from the image display system 1 displays a color image by using the field sequential process (time sharing display process), and the laser beams of different colors are emitted from the corresponding laser light source units 2 to 4 sequentially in a time sharing manner so that the laser beams of the different colors emitted intermittently and scanned over the screen are perceived as a unified color afterimage.

The relay optical system 7 comprises collimator lenses 11 to 13 for converting the laser beams of different colors emitted from the corresponding laser light source units 2 to 4 into parallel beams of the different colors, first and second dichroic mirrors 14 and 15 for directing laser beams of the different colors exiting the collimator lenses 11 to 13 in a prescribed direction, a diffusion plate 16 for diffusing the laser beams guided by the dichroic mirrors 14 and 15, and a field lens 17 for converting the laser beam transmitted through the diffusion plate 16 into a converging laser beam.

If the side of the projection optical system 8 from which the laser beam is emitted to the screen S is defined as the front side, the blue laser light source unit 4 emits the blue laser beam in the rearward direction. The green and red laser light source units 2 and 3 emit the green laser beam and red laser beam, respectively, in a direction perpendicular to the blue laser beam. The blue, red and green laser beams are conducted to a common light path by the two dichroic mirrors 14 and 15. In other words, the blue laser beam and green laser beam are conducted to a common light path by the first dichroic mirror 14, and the blue laser beam, red laser beam and green laser beam are conducted to a common light path by the second dichroic mirror 15.

The surface of each dichroic mirror 14, 15 is coated with a film that selectively transmits light of a prescribed wavelength while reflecting light of other wavelengths. The first dichroic mirror 14 transmits the blue laser beam while reflecting the green laser beam, and the second dichroic mirror 15 transmits the red laser beam while reflecting the blue and green laser beams.

These optical components are received in a housing 21 which is made of thermally conductive material such as aluminum and copper so as to serve as a heat dissipator for dissipating the heat generated from the laser light source units 2 to 4.

The green laser light source unit 2 is mounted on a mounting plate 22 secured to the housing 21 and extending laterally from the main body of the housing 21. The mounting plate 22 extends from the corner between a front wall 23 and a side wall 24 of the housing 21 (which are located on the front and lateral side of the storage space receiving the relay optical system 7, respectively) in a direction perpendicular to the side wall 24. The red laser light source unit 3 is retained in a holder 25 which is in turn attached to the outer surface of the side wall 24, and the blue laser light source unit 4 is retained in a holder 26 which is in turn attached to the outer surface of the front wall 23.

The red and blue laser light source units 3 and 4 are each prepared in a CAN package in which a laser chip supported by a stem is placed on the central axial line of a can so as to emit a laser beam in alignment with the central axial line of the can and out of a glass window provided on the can. The red and blue laser light source units 3 and 4 are secured to the respective holders 25 and 26 by being press fitted into mounting holes 27 and 28 formed in the corresponding holders 25 and 26. The heat generated in the laser chips of the red and blue laser light source units 3 and 4 is transmitted to the housing 21 via the holders 25 and 26, and is dissipated to the surrounding environment from the housing 21. The holders 25 and 26 may be made of thermally conductive material such as aluminum and copper.

The green laser light source unit 2 comprises a semiconductor laser 31 for producing an excitation laser beam, a FAC (Fast-Axis Collimator) lens 32 and a rod lens 33 for collimating the excitation laser beam produced from the semiconductor lens 31, a laser medium 34 for producing a base wavelength laser beam (infrared laser beam) through excitation by the excitation laser beam, a wavelength converting device 35 for producing a half wavelength laser beam (green laser beam) by converting the wavelength of the base wavelength laser beam, a concave mirror 36 for forming a resonator in cooperation with the laser medium 34, a glass cover 37 for preventing the leakage of the excitation laser beam and base wavelength laser beam, a base 38 for supporting the various component parts and a cover member 39 covering the various components.

The green laser light source unit 2 is fixedly attached to the mounting plate 22 via the base 38, and a gap of a prescribed width (such as 0.5 mm or less) is formed between the green laser light source unit 2 and the side wall 24 of the housing 21. Thereby, the heat generated from the green laser light source unit 2 is insulated from the red laser light source unit 3 so that the red laser light source unit 3 having a relatively low tolerable temperature is prevented from heat, and is enabled to operate in a stable manner. To obtain a required adjustment margin (such as about 0.3 mm) for the optical center line of the red laser light source unit 3, a certain gap (such as 0.3 mm or more) is provided between the green laser light source unit 2 and the red laser light source unit 3.

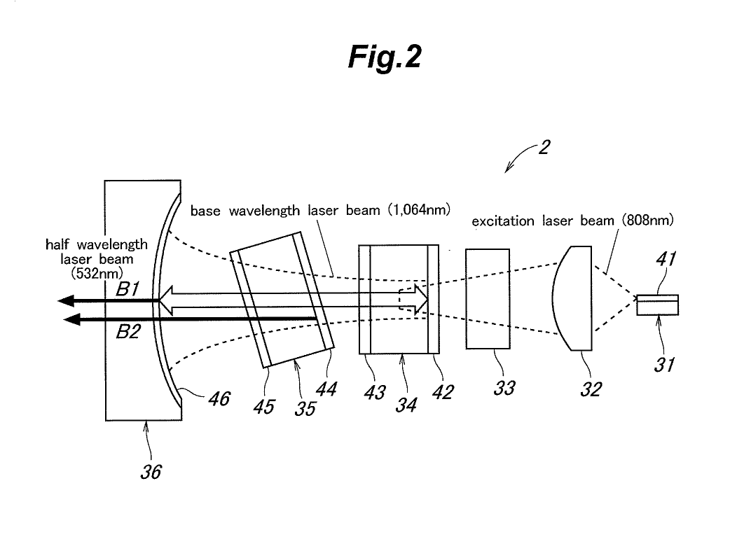

FIG. 2 is a diagram showing the optical structure of the green laser light source unit 2. The semiconductor laser 31 comprises a laser chip 41 that produces an excitation laser beam having a wavelength of 808 nm. The FAC lens 32 reduces the expansion of the laser beam in the direction of the fast axis of the laser beam (which is perpendicular to the optical axial line and in parallel with the plane of the paper of the drawing), and the rod lens 33 reduces the expansion of the laser beam in the direction of the slow axis of the laser beam (which is perpendicular to the plane of the paper of the drawing).

The laser medium 34 consists of a solid laser crystal that produces a base wavelength laser beam (infrared laser beam) having a wavelength of 1,064 nm by the excitation caused by the excitation laser beam having the wavelength of 808 nm. The laser medium 34 may be prepared by doping inorganic optically active substance (crystal) consisting of Y (yttrium) and VO₄ (vanadate) with Nd (neodymium). In particular, yttrium in YVO₄ is substituted by Nd⁺³ which is fluorescent.

The side of the laser medium 34 facing the rod lens 33 is coated with a film 42 designed to prevent the reflection of the excitation laser beam having the wavelength of 808 nm, and fully reflect the base wavelength laser beam having the wavelength of 1,064 nm and the half wavelength laser beam having the wavelength of 532 nm. The side of the laser medium 34 facing the wavelength converting device 35 is coated with a film 43 designed to prevent the reflection of both the base wavelength laser beam having the wavelength of 1,064 nm and the half wavelength laser beam having the wavelength of 532 nm.

The wavelength converting device 35 consists of a SHG (Second Harmonics Generation) device that is configured to convert the base wavelength laser beam (infrared laser beam) having the wavelength of 1,064 nm generated by the laser medium 34 into the half wavelength laser beam having the wavelength of 532 nm (green laser beam).

The side of the wavelength converting device 35 facing the laser medium 34 is coated with a film 44 that prevents the reflection of the base wavelength laser beam having the wavelength of 1,064 nm, and fully reflects the half wavelength laser beam having the wavelength of 532 nm. The side of the wavelength converting device 35 facing the concave mirror 36 is coated with a film 45 that prevents the reflection of both the base wavelength laser beam having the wavelength of 1,064 nm and the half wavelength laser beam having the wavelength of 532 nm.

The concave mirror 36 is provided with a concave surface that faces the wavelength converting device 35, and the concave surface is coated with a film 46 that fully reflects the base wavelength laser beam having the wavelength of 1,064 nm, and prevents the reflection of the half wavelength laser beam having the wavelength of 532 nm. Thereby, the base wavelength laser beam having the wavelength of 1,064 nm is amplified by resonance between the film 42 of the laser medium 34 and the film 46 of the concave mirror 36.

The wavelength converting device 35 converts a part of the base wavelength laser beam having the wavelength of 1,064 nm received from the laser medium 34 into the half wavelength laser beam having the wavelength of 532 nm, and the remaining part of the base wavelength laser beam having the wavelength of 1,064 nm that has transmitted through the wavelength converting device 35 without being converted is reflected by the concave mirror 36, and re-enters the wavelength converting device 35 to be converted into the half wavelength laser beam having the wavelength of 532 nm. The half wavelength laser beam having the wavelength of 532 nm is reflected by the film 44 of the wavelength converting device 35, and exits the wavelength converting device 35.

If the laser beam B1 that enters the wavelength converting device 35 from the laser medium 34, and exits the wavelength converting device 35 after being converted of the wavelength thereof overlaps with the laser beam B2 that is reflected by the concave mirror 36, and exits the wavelength converting device 35 after being reflected by the film 44, the half wavelength laser beam having the wavelength of 532 nm and the base wavelength laser beam having the wavelength of 1,064 nm may interfere with each other, and the laser output may be reduced as a result.

To avoid this problem, the wavelength converting device 35 is tilted with respect to the optical axial line so that the half wavelength laser beam having the wavelength of 532 nm and the base wavelength laser beam having the wavelength of 1,064 nm are prevented from interfering with each other owing to the refraction of the laser beams B1 and B2 at the incident surface 35a and the exit surface 35b, and the reduction in the laser output can be avoided.

The glass cover 37 shown in FIG. 1 is formed with a film that prevents the leakage of the base wavelength laser beam having the wavelength of 1,064 nm and the excitation laser beam having the wavelength of 808 nm to the outside.

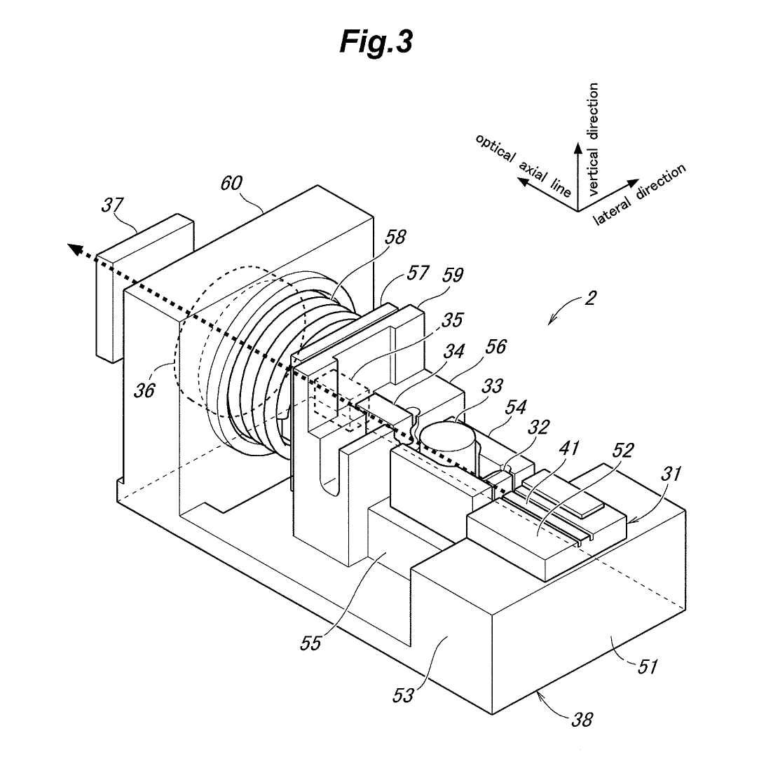

FIG. 3 is a perspective view of the green laser light source unit 2. The semiconductor laser 31, FAC lens 32, rod lens 33, laser medium 34, wavelength converting device 35 and concave mirror 36 are integrally supported by the base 38 which has a bottom surface 51 extending in parallel with the optical axial line. The direction perpendicular to the bottom surface 51 of the base 38 is referred to as the vertical direction, and the direction perpendicular to both the vertical direction and the optical axial line is referred to as the lateral direction in the following description. The side of the base 38 adjacent to the bottom surface 51 is referred to as the lower side, and the side of the base 38 facing away from the bottom surface 51 is referred to the upper side in the following description, but this may not coincide with the upper and lower directions of the apparatus in use.

The semiconductor laser 31 is formed by mounting the laser chip 41 that emits the laser beam on a mount member 52. The laser chip 41 is provided with a rectangular shape elongated in the direction of the optical axial line, and is fixedly attached to a laterally central part of an upper surface of the mount member 52 which is also provided with a rectangular shape with a light emitting surface of the laser chip 41 facing the FAC lens 32.

The FAC lens 32 and rod lens 33 are mounted on a collimator lens holder 54 which is in turn supported by a support portion 55 integrally formed on the base 38. The collimator lens holder 54 is mounted on the support portion 55 so as to be moveable in the direction of the optical axial line so that the position of the collimator lens holder 54 and, hence, the position of the FAC lens 32 and rod lens 33 can be adjusted in the direction of the optical axial line. The FAC lens 32 and rod lens 33 may be fixedly attached to the collimator lens holder 54 by using a bonding agent prior to the adjustment of the position in the direction of the optical axial line, and the collimator lens holder 54 may be fixedly attached to the base 55 by using a bonding agent following the adjustment of the position in the direction of the optical axial line.

The laser medium 34 is retained by a retaining portion 56 which is in turn integrally formed with the base 38. The laser medium 34 may be fixedly attached to the retaining portion 56 by using a bonding agent.

The wavelength converting device 35 is retained by a wavelength converting device holder 57, which is mounted on a holder support portion 59 integrally formed with the base 38, in a laterally moveable and freely tiltable manner so that the lateral position and inclination angle (with respect to the optical axial line) of the wavelength converting device 35 may be adjusted. The wavelength converting device holder 57 is described in greater detail later in this description. The wavelength converting device 35 may be fixedly attached to the wavelength converting device holder 57 by using a bonding agent prior to the positional adjustment, and the wavelength converting device holder 57 may be fixedly attached to the holder support portion 59 by using a bonding agent following the positional adjustment.

The wavelength converting device holder 57 is retained by being pressed against the holder support portion 59 under a spring force of a compression coil spring 58 which is interposed between a concave mirror support portion 60 and the wavelength converting device holder 57 in a compressed state so as to urge the wavelength converting device holder 57 against the holder support portion 59. The spring 58 in this case consists of a compression spring disposed concentrically around the optical axial line, but may also consist of a spring of any other type such as a sheet spring.

The concave mirror 36 is retained by the concave mirror support portion 60 which is integrally formed with the base 38. The glass cover 37 is retained in a window formed in the cover member 39.

The bonding agent that is used in bonding various components together such as the bonding between the holder support portion 59 and the wavelength converting device holder 57 preferably consists of a UV curing bonding agent.

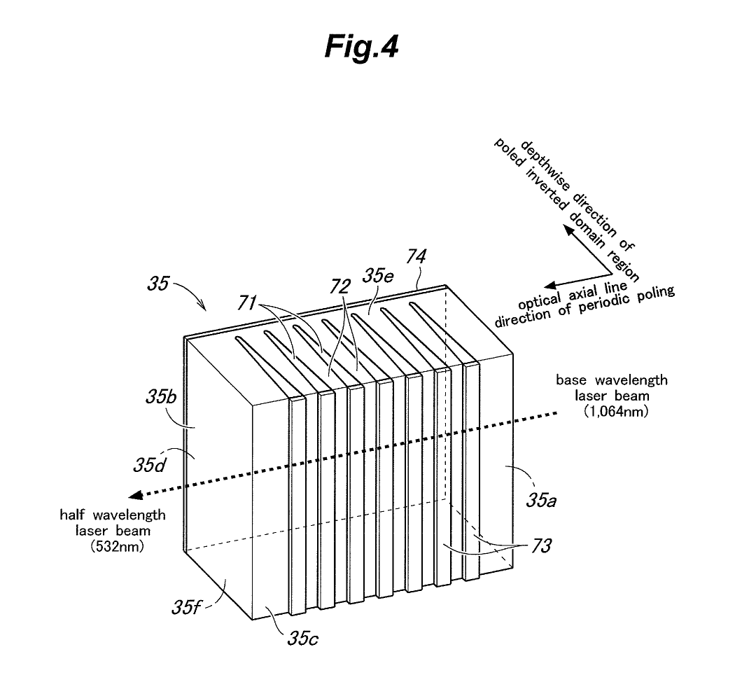

FIG. 4 is a perspective view of a wavelength converting device 35 used in the green laser light source unit 2. The wavelength converting device 35 includes a ferroelectric crystal formed with a periodically poled inverted domain structure including poled inverted domain regions 71 and non-poled inverted domain regions 72 in an alternating arrangement. When the base wavelength laser beam is received in the direction along which the poled inverted domain regions 71 are arranged, the laser beam of twice the frequency or the half wavelength laser beam can be obtained owing to the doubling of the frequency of the incident laser beam by the quasi-phase-matching.

When an electric field opposite in the direction of polarization of the ferroelectric crystal is applied to the ferroelectric crystal by using periodic electrodes 73 and an opposing electrode 74, the poles of the parts corresponding to the periodic electrodes 73 are reversed, and wedge shaped poled inverted domain regions 71 extend from the periodic electrodes 73 towards the opposing electrode 74.

In practice, the periodically poled inverted domain structure is formed on a ferroelectric crystal substrate, and is cut into individual wavelength converting devices 35 of prescribed dimensions. The incident surface 35a and exit surface 35b are formed on each wavelength converting device 35 as planes parallel to the depthwise direction of the poled inverted domain regions 71 by means of a precision optical grinding process. The periodic electrodes 73 and the opposing electrode 74 are removed from the side surfaces 35c and 35d by grinding following the poling process. The ferroelectric crystal may consist of LN (lithium niobate) added with MgO.

Each poled inverted domain region 71 is wedge shaped, and gets progressively narrower with depth. Therefore, by displacing the wavelength converting devices 35 in the direction of the depth of the poled inverted domain region 71, the ratio between the poled inverted domain regions 71 and non-poled inverted domain regions 72 that are located along the optical axial line changes, and this causes a corresponding change in the wavelength converting efficiency. Based on this consideration, the position of the wavelength converting devices 35 with respect to the optical axial line of the laser beam is adjusted so as to maximize the laser output. This adjustment process will be described in greater detail in the following description.

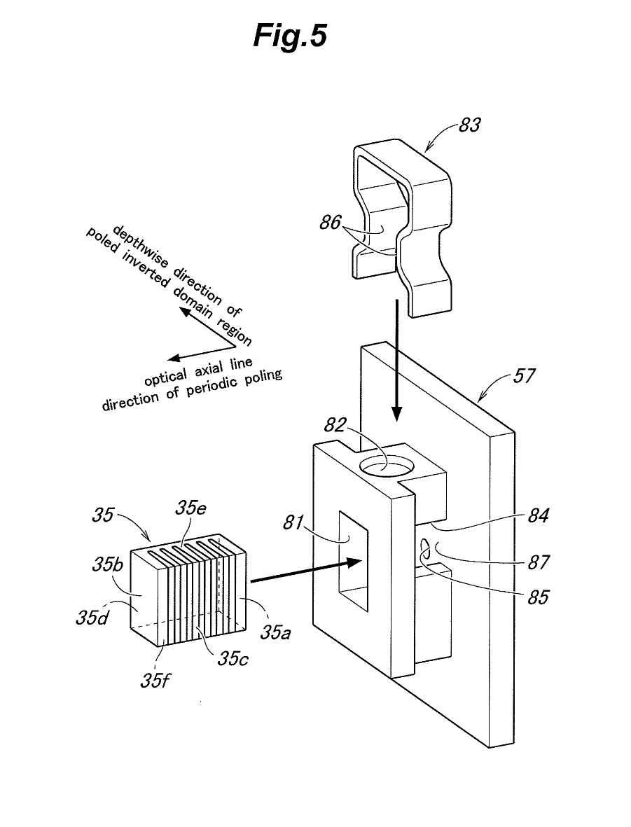

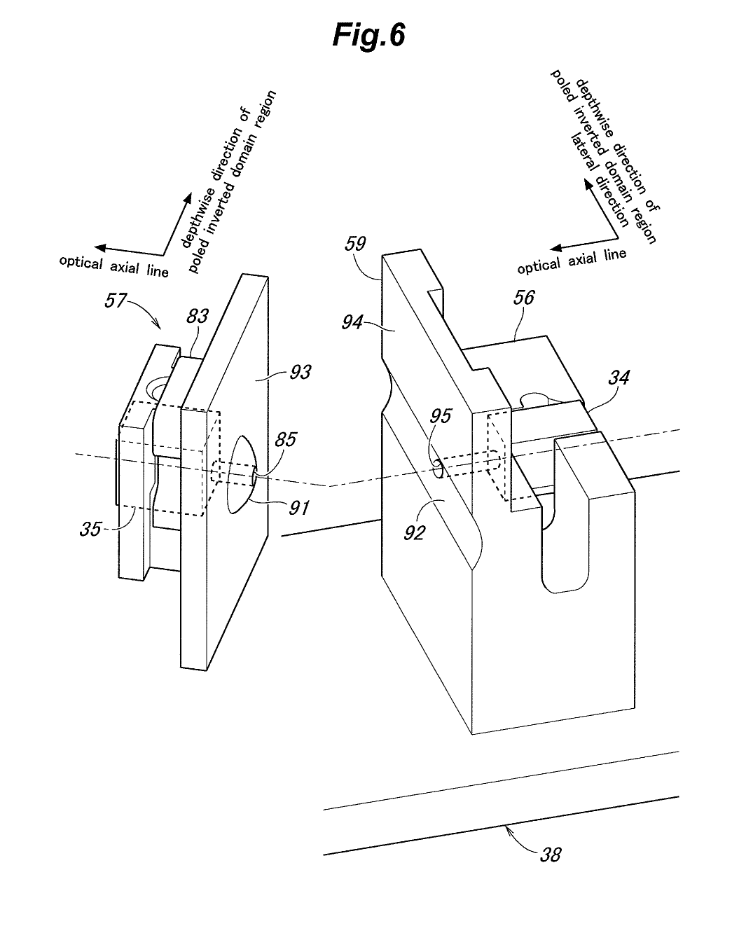

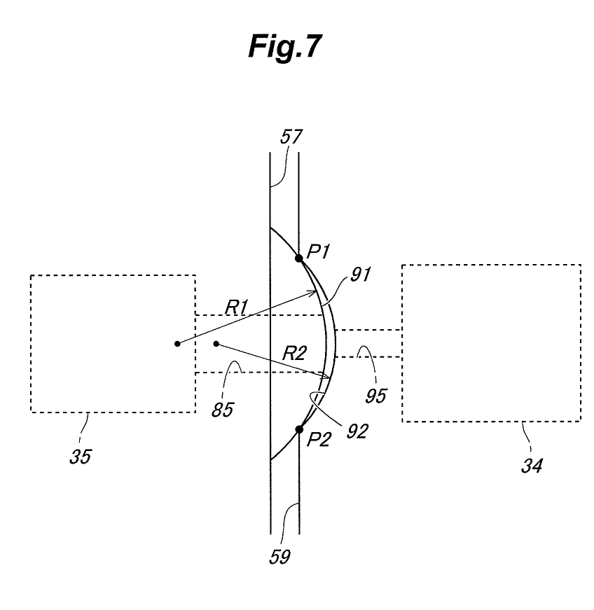

FIG. 5 is a perspective view of the wavelength converting device holder 57. FIG. 6 is a perspective view of the wavelength converting device holder 57 and the holder support portion 59 of the base 38. FIG. 7 is an enlarged side view showing a projection 91 of the wavelength converting device holder 57 and a recess 92 of the holder support portion 59.

As shown in FIG. 5, the wavelength converting device holder 57 comprises a receiving hole 81 for receiving the wavelength converting devices 35, a bonding agent receiving hole 82 that receives a bonding agent for attaching the wavelength converting devices 35 to the wavelength converting device holder 57, an opening 84 for allowing a grounding plate 83 to engage the wavelength converting devices 35 received in the receiving hole 81 and an optical path hole 85 for conducting the laser beam onto the wavelength converting devices 35 received in the receiving hole 81.

The incident surface 35a and exit surface 35b are formed as highly precise and highly parallel planes by precision grinding, but the side surfaces 35c and 35d, top surface 35e and bottom surface 35f are not finished with as high precision as the incident surface 35a and exit surface 35b in terms of being perpendicular and parallel, and each individual wavelength converting device 35 is cut apart from the substrate with some manufacturing errors. Therefore, in order to properly position the individual wavelength converting devices 3, the incident surface 35 finished with a high precision is brought into contact with a reference surface 84 through which the optical path hole 85 is passed.

The grounding plate 83 is formed by a sheet spring bent into the shape of letter U, and may be made of metallic material or other electro-conductive material. The grounding plate 83 is mounted on the wavelength converting device holder 57 so as to hold the wavelength converting device 35 from two lateral sides. More specifically, the grounding plate 83 is provided with a pair of contact portions 86 that resiliently engage the two side surfaces 35c and 35d opposing each other in the depthwise direction of the poled inverted domain regions 71. Thereby, the two side surfaces 35c and 35d of the wavelength converting device 35 are electrically connected to each other, and held at a same voltage level so that the changes in the refractive index owing to charge-up can be avoided.

As shown in FIG. 6, the wavelength converting device holder 57 is provided with a spherical projection 91, and the holder support portion 59 is provided with a part-cylindrical recess 91 having a central axial line extending in the lateral direction. By fitting the spherical projection 91 of the wavelength converting device holder 57 into the part-cylindrical recess 91 of the holder support portion 59, the wavelength converting device holder 57 and the holder support portion 59 are secured to each other so that the opposing surfaces 93 and 94 thereof are disposed in parallel to each other. When assembled, the central axial line of the part-cylindrical recess 91 of the holder support portion 59 extends in the depthwise direction of the poled inverted domain regions 71 of the wavelength converting device 35. Thereby, the wavelength converting device holder 57 can be not only linearly adjusted in the depthwise direction of the poled inverted domain regions 71 of the wavelength converting device 35 but also angularly adjusted in any desired direction with respect to the holder support portion 59.

As shown in FIG. 7, the projection 91 of the wavelength converting device holder 57 is formed with a part-spherical surface having a greater radius than that of the cylindrical surface of the recess 92 of the holder support portion 59. As a result, the recess 92 engages the projection 91 at two points P1 and P2 located on either vertical end of the recess 92 so that the projection 91 is retained in the recess 92 without any play, and the wavelength converting device holder 57 is prevented from moving in any direction other than the depthwise direction of the poled inverted domain regions 71. If the radius of the sphere of the projection 91 were smaller than that of the cylindrical surface of the recess 92, some play would be produced between the projection 91 and recess 92. If the radius of the sphere of the projection 91 were identical to that of the cylindrical surface of the recess 92, the projection 91 may not be able to move smoothly with respect to the recess 92.

As shown in FIG. 6, the optical path hole 85 for guiding the laser beam to the wavelength converting device 35 retained by the wavelength converting device holder 57 is formed centrally through the projection 91. The holder support portion 59 is integrally formed with the retaining portion 56 for the laser medium 34, and an optical path hole 95 for guiding the laser beam emitted from the laser medium 34 is formed centrally in the recess 92 of the holder support portion 59. By thus forming the optical path holes 85 and 95 for guiding the laser beam centrally in the projection 91 and recess 92, and causing the projection 91 and recess 92 to engage each other on the optical axial line, the position of the wavelength converting device 35 along the optical axial line can be prevented from changing to any significant extent even by the tilting of the wavelength converting device holder 57.

As shown in FIG. 7, the optical path hole 85 of the wavelength converting device holder 57 and the optical path hole 95 of the holder support portion 59 are both circular in shape, and the former is greater than the latter in diameter. Thereby, even when the positional relationship between the optical path hole 85 of the wavelength converting device holder 57 and the optical path hole 95 of the holder support portion 59 owing to the displacement and tilting of the wavelength converting device holder 57 at the time of positional adjustment, the optical path holes 85 and 95 are not blocked for the laser beam to pass through.

The wavelength converting device holder 57 and the holder support portion 59 are secured to the base 22 by using a bonding agent following the positional and angular adjustment. This can be accomplished by depositing a certain amount of the bonding agent in the recess 92 of the holder support portion 59 or a groove separately formed therein adjacent to the projection 91. Thereby, the tilting of the wavelength converting device holder 57 due to the shrinking of the bonding agent during the course of curing can be avoided.

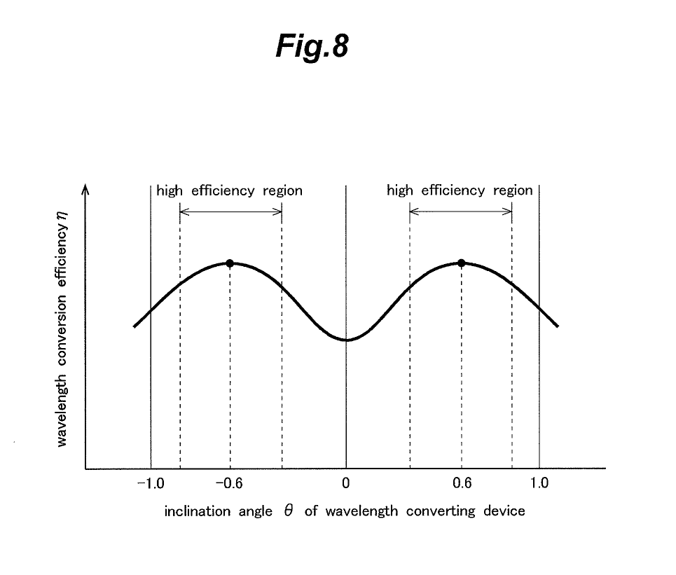

FIG. 8 is a graph showing the relationship between the wavelength conversion efficiency η and the inclination angle θ of the wavelength converting device 35. The wavelength conversion efficiency η of the wavelength converting device 35 changes in dependence on the inclination angle θ of the wavelength converting device 35. In particular, the wavelength conversion efficiency η is low when the inclination angle of the wavelength converting device 35 relative to the optical axial line is zero (θ=0), and can be made higher by increasing the inclination angle of the wavelength converting device 35.

This is due to the fact that, when the inclination angle is small, as shown in FIG. 2, the laser beams B1 and B2 overlap with each other, and this causes an interference between the half wavelength laser beam having the wavelength of 532 nm and the base wavelength laser beam having the wavelength of 1,064 nm. When the wavelength converting device 35 is tilted with respect to the optical axial line, owing to the refraction at the incident surface 35a and exit surface 35b, the laser beams B1 and B2 are laterally shifted from each other, and the reduction in the laser output owing to the interference can be avoided.

In particular, an adjustment margin of a prescribed range (±0.4 degrees, for instance) is defined around each of two peak points (θ=±0.6 degrees in this case) of the wavelength conversion efficiency η for the wavelength converting device 35, and the wavelength converting device holder 57 and the holder support portion 59 are configured such that the tilting angle θ of the wavelength converting device 35 can be adjusted within this adjustment margin.

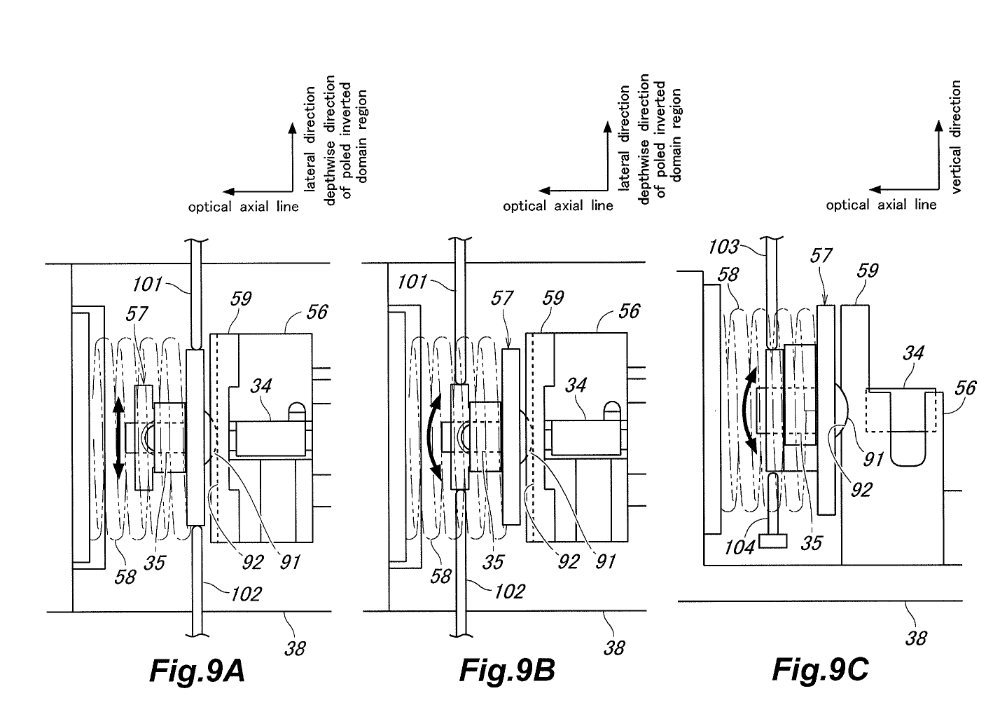

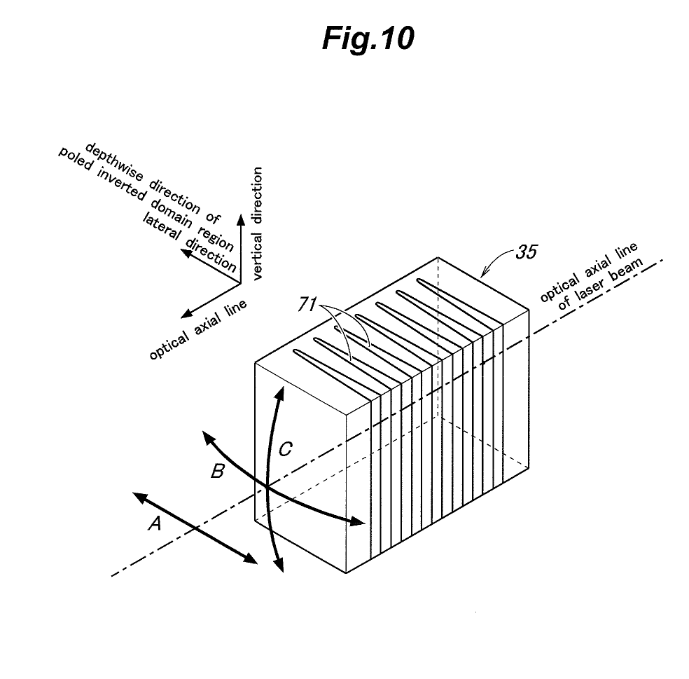

FIGS. 9a and 9b are plan views and FIG. 9c is a side view showing the process of adjusting the position and angle of the wavelength converting device holder 57. FIG. 10 is a perspective view showing how the position and angle of the wavelength converting device are adjusted.

FIG. 9a shows the lateral positional adjustment of the wavelength converting device holder 57. When a part of the wavelength converting device holder 57 adjacent to the projection 91 (along the optical axial line) is pressed from two lateral sides by using a pair of jigs 101 and 102 laterally opposing each other, the projection 91 of the wavelength converting device holder 57 can be displaced along the recess 92 of the holder support portion 59 in a desired direction, and the wavelength converting device holder 57 can be thereby laterally displaced. As a result, the wavelength converting device 35 can be displaced in the depthwise direction of the poled inverted domain regions 71 with respect to the optical axial line of the laser beam as indicated by arrow A in FIG. 10.

FIG. 9b shows the angular adjustment of the wavelength converting device holder 57 in the lateral direction. In this case, a part of the wavelength converting device holder 57 at some distance (along the optical axial line) away from the projection 91 is pressed by a pair of jigs 101 and 102 laterally opposing each other, the wavelength converting device holder 57 can be tilted in the lateral direction around the projection 91 of the wavelength converting device holder 57. Thereby, the wavelength converting device 35 can be tilted in the lateral direction with respect to the optical axial line of the laser beam as indicated by arrow B in FIG. 10.

FIG. 9c shows the angular adjustment of the wavelength converting device holder 57 in the vertical direction. In this case, a part of the wavelength converting device holder 57 at some distance (along the optical axial line) away from the projection 91 is pressed by a pair of jigs 103 and 104 vertically opposing each other so that the wavelength converting device holder 57 can be tilted in the vertical direction around the projection 91 of the wavelength converting device holder 57. Thereby, the wavelength converting device 35 can be tilted in the vertical direction with respect to the optical axial line of the laser beam as indicated by arrow C in FIG. 10.

The process of adjusting the position and angle of the wavelength converting device 35 is described in the following. First of all, the position of the wavelength converting device 35 is adjusted in the lateral direction (in the depthwise direction of the poled inverted domain regions 71). This adjustment is performed while monitoring the laser output by using a power meter, and is performed so as to maximize the laser output by displacing the wavelength converting device holder 57 in the lateral direction as shown in FIG. 9a.

Thereafter, the angle θ of the wavelength converting device holder 57 is adjusted so that the inclination angle θ of the wavelength converting device 35 with respect to the optical axial line is zero (see FIG. 8). This angular adjustment is performed while monitoring the beam shape of the laser beam. As shown in FIGS. 9b and 9c, the wavelength converting device 35 is tilted both vertically and laterally until the laser beam is given as a single beam. This puts the inclination angle θ of the wavelength converting device 35 to zero.

Finally, the angle of the wavelength converting device holder 57 is adjusted so that the inclination angle θ of the wavelength converting device 35 with respect to the optical axial line changes within the adjustment margin that maximizes the wavelength conversion efficiency η (see FIG. 8). This angular adjustment is performed while monitoring the laser output by using a power meter. As shown in FIGS. 9b and 9c, the wavelength converting device holder 57 is angularly adjusted in both the vertical and lateral directions so as to maximize the laser output. Thereby, the inclination angle of the wavelength converting device 35 is put within the prescribed range of high wavelength conversion efficiency and the interference caused by the overlapping of the laser beams B1 and B2 can be avoided as shown in FIG. 2.

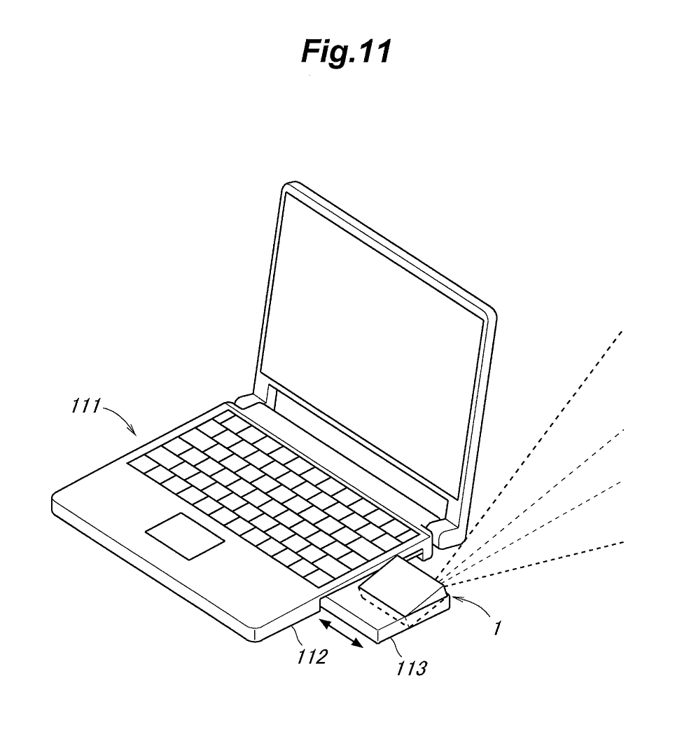

FIG. 11 is a perspective view of an information processing apparatus 111 incorporated with an image display system 1 embodying the present invention. The information processing apparatus 111 of the illustrated embodiment is constructed as a laptop computer including a housing 112 having a keyboard formed on one side (upper side in FIG. 11) thereof, and a display panel hinged to the housing 112 in a per se known manner. The housing 112 internally defines a storage space behind the keyboard in which an image display system 1 can be received from a side end of the housing 112, and can be pulled out from the side end as required. The image display system 1 includes a control unit 113 slidably received in the internal storage space, and an image display system 1 pivotally connected to the free end of the control unit 113. By vertically tilting the image display system 1 relative to the control unit 113, a laser beam emitted from the image display system 1 can be directed onto an external screen S.

The projection 91 was provided on the wavelength converting device holder 57 and the recess 92 was provided in the holder support portion 59 in the foregoing embodiment as illustrated in FIG. 6, but it is also possible to provide the recess 92 in the wavelength converting device holder 57 and the projection 9 on the holder support portion 59.

The projection 91 was provided with a part-spherical shape and the recess 92 was provided with a part-cylindrical shape (a part-circular cross section) in the foregoing embodiment, but the recess 92 may also be provided with any other cross sectional shape, such as trapezoidal or rectangular shape, as long as the projection 91 engages the recess 92 at extreme end points P1 and P2 located on either side the central point, preferably, in a symmetric relationship.

In the foregoing embodiment, the laser chip 41 of the green laser light source unit 2, the laser medium 34 and the wavelength converting device 35 generated the excitation laser beam having a wavelength of 808 nm, the base wavelength laser beam (infrared laser beam) having the wavelength of 1,064 nm and the half wavelength laser beam having the wavelength of 532 nm (green laser beam), respectively, but the present invention is not limited by this example. As long as the laser beam emitted from the green laser light source unit 2 can be perceived as green color, the output may be a laser beam having a peak wavelength range of 500 nm to 560 nm, for instance.

The reference surface 87 for positioning the wavelength converting device 35 consisted of a single plane, and the exit surface 35b of the wavelength converting device 35 was configured to contact the reference surface 87 over the entire surface thereof in the foregoing embodiment as illustrated in FIG. 5. However, it is also possible to provide three projections having a same height around the optical path hole 85, in place of the reference surface 87, for positioning the wavelength converting device 35 by using the top surfaces of the projections as a reference surface. In such a case, the wavelength converting device 35 would be supported by three points.

When the reference surface 87 consists of a single surface for positioning the wavelength converting device 35 as in the embodiment illustrated in FIG. 5, owing to the inevitable limit in the precision of the planarity of the reference surface, some play in the mounting structure is inevitable, and this causes some uncertainty in the angular position of the wavelength converting device 35. The angular change caused by the play in the mounting structure for the wavelength converting device 35 is highly unpredictable, and this may cause some fluctuations in the angular position of the wavelength converting device 35. Furthermore, the bonding agent for mounting the wavelength converting device 35 shrinks during the course of curing, and this occurs to varying degrees depending on each particular situation. This also contributes to the amplification of the variations in the angular position of the wavelength converting device 35.

On the other hand, when the wavelength converting device 35 is supported by three projections at three points, the play in the mounting structure for the wavelength converting device 35 may be eliminated, and the wavelength converting device 35 may be supported in a more stable manner. Also, the fluctuations in the angular position of the wavelength converting device 35 can be reduced because the angular position of the wavelength converting device 35 are much less affected by the causes of the fluctuations such as the existence of dents in the reference surface or inclusion of foreign matters. Thereby, the angular adjustment margin for the wavelength converting device 35 can be reduced, and the yield of the manufacturing process can be improved. Also, the work involved in the angular adjustment of the wavelength converting device 35 can be simplified.

### Second Embodiment

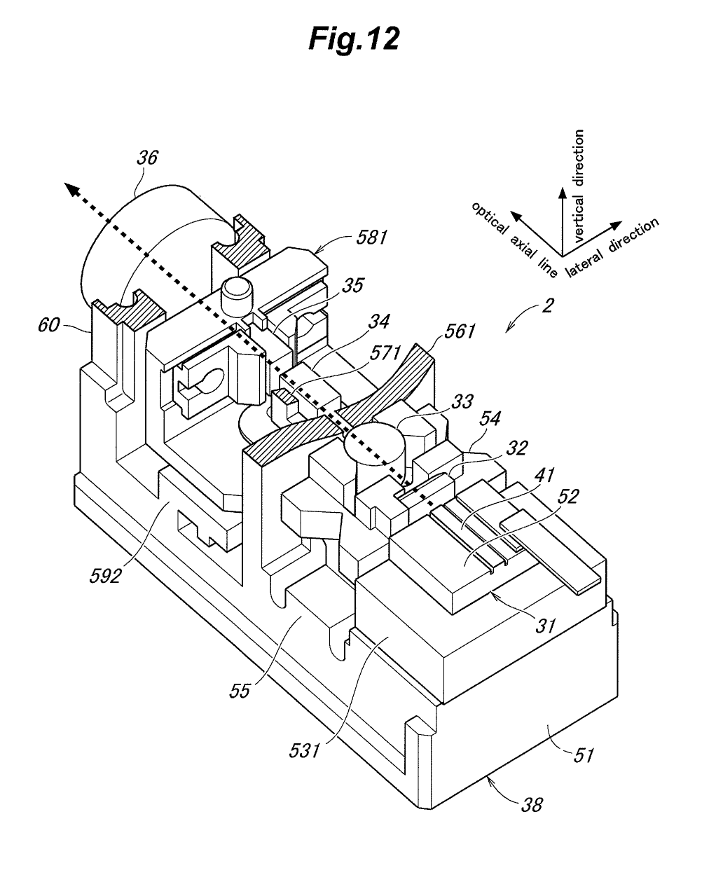

A second embodiment of the present invention is described in the following with reference to FIGS. 12 to 18.

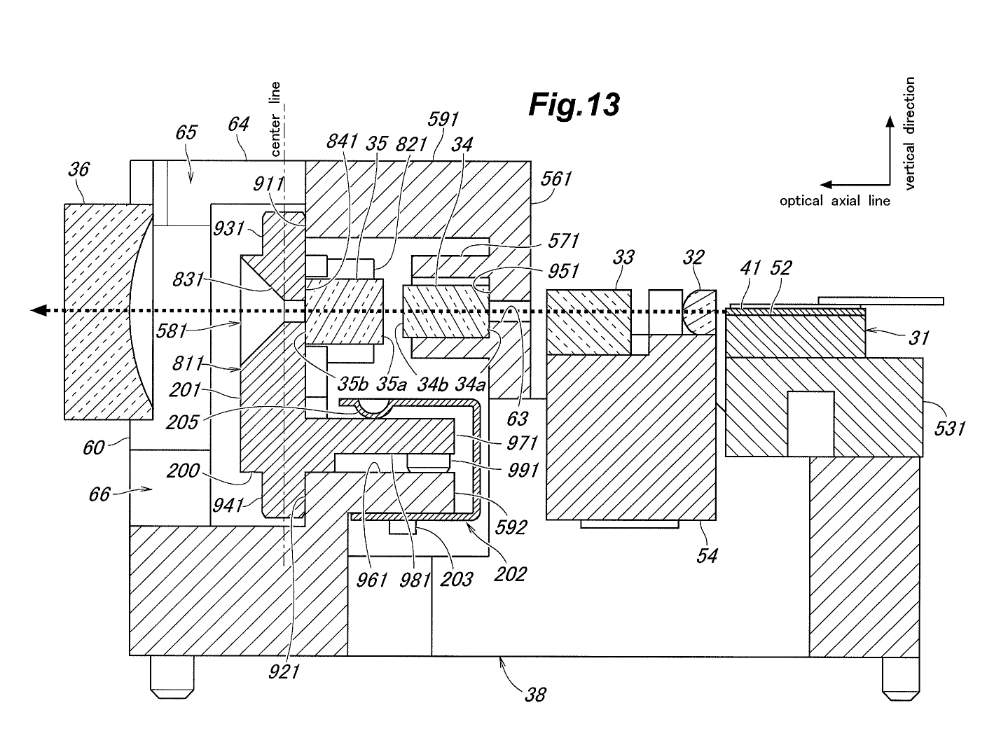

FIG. 12 is a view similar to FIG. 3 showing a green laser light source unit 2 given as a second embodiment of the present invention, and FIG. 13 is a cross sectional view of the green laser light source unit 2. In the following description, the parts corresponding to those of the previous embodiment are denoted with like numerals without repeating the description of such parts.

As shown in FIG. 12, a semiconductor laser 31, a FAC lens 32, a rod lens 33, a laser medium 34, a wavelength converting device 35 and a concave mirror 36 are integrally supported by a base 38 which has a bottom surface 51 extending in parallel with the optical axial line. The direction perpendicular to the bottom surface 51 of the base 38 is referred to as the vertical direction, and the direction perpendicular to both the vertical direction and the optical axial line is referred to as the lateral direction in the following description. The side of the base 38 adjacent to the bottom surface 51 is referred to as the lower side, and the side of the base 38 facing away from the bottom surface 51 is referred to the upper side in the following description, but this may not coincide with the upper and lower directions of the apparatus in use.

The semiconductor laser 31 is formed by mounting a laser chip 41 that emits the laser beam on a mount member 52. The laser chip 41 is provided with a rectangular shape elongated in the direction of the optical axial line, and is fixedly attached to a laterally central part of an upper surface of the mount member 52 which is also provided with a rectangular shape with a light emitting surface of the laser chip 41 facing the FAC lens 32. The semiconductor laser 31 is fixedly attached to the base 38 via a mounting member 531 which may be made of material having a high thermal conductivity such as copper and aluminum so that the heat generated from the laser chip 41 may be dissipated to the environment via the base 38.

The FAC lens 32 and rod lens 33 are mounted on a collimator lens holder 54 which is in turn supported by a support portion 55 integrally formed on the base 38. The collimator lens holder 54 is mounted on the support portion 55 so as to be moveable in the direction of the optical axial line so that the position of the collimator lens holder 54 and, hence, the position of the FAC lens 32 and rod lens 33 can be adjusted in the direction of the optical axial line. The FAC lens 32 and rod lens 33 may be fixedly attached to the collimator lens holder 54 by using a bonding agent prior to the adjustment of the position in the direction of the optical axial line, and the collimator lens holder 54 may be fixedly attached to the base 55 by using a bonding agent following the adjustment of the position in the direction of the optical axial line.

The laser medium 34 is supported by a laser medium support portion 561 integrally formed with the base 38. As shown in FIGS. 12 and 13, the laser medium support portion 561 extends vertically upright from the base 38 and extends laterally substantially over the entire lateral extent of the base 38 like a partition wall. A laser medium retaining portion 571 for retaining the laser medium 34 extends from the side of the laser medium support portion 561 facing away from the collimator lens holder 54. The laser medium support portion 561 is provided with an optical path hole 63 for conducting the laser beam emitted from the rod lens 33 to the laser medium 34. The laser medium 34 may be fixedly attached to the laser medium retaining portion 571 by using a bonding agent.

Referring to FIG. 12 once again, the wavelength converting device 35 is retained by a wavelength converting device holder 581 which is supported by the base 38 so as to be laterally moveable and tiltable with respect to the optical axial line. Hence, the wavelength converting device 35 can be adjusted linearly in the lateral direction and angularly with respect to the optical axial line. The wavelength converting device holder 581 will be described in greater detail in the following description. The wavelength converting device 35 may be fixedly attached to the wavelength converting device holder 581 by using a bonding agent prior to the positional adjustment, and the wavelength converting device holder 581 may be fixedly attached to the base 38 by using a bonding agent following the positional adjustment.

The concave mirror 36 is retained by the concave mirror support portion 60 which is integrally formed with the base 38.

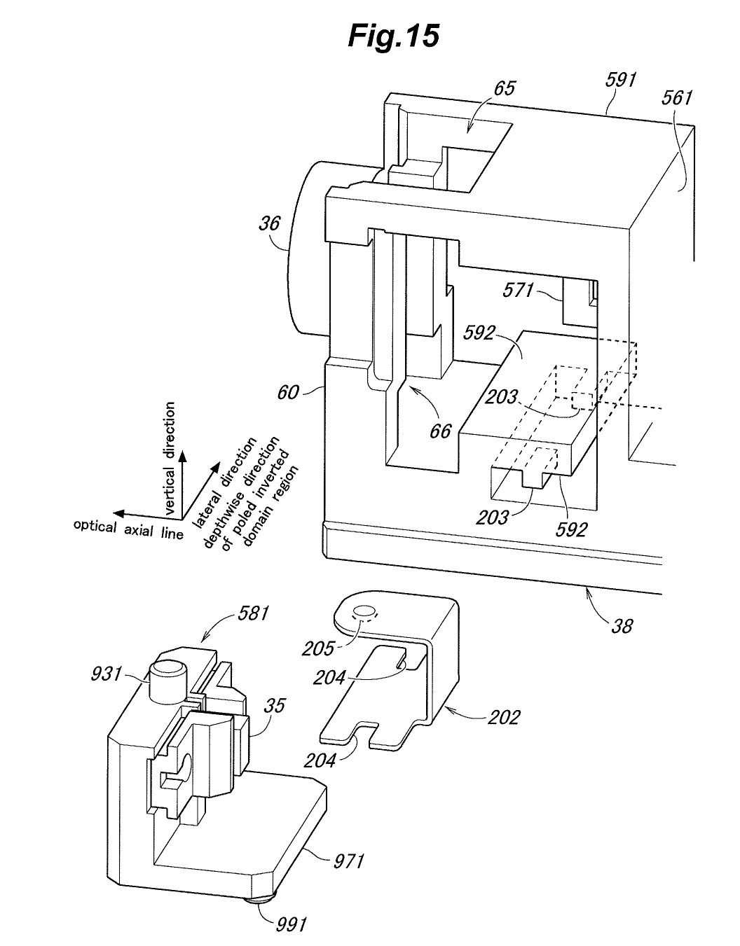

As shown in FIG. 13, the base 38 is provided with a bridge portion 64 that extends between the upper ends of the concave mirror support portion 60 and the laser medium support portion 561. The bridge portion 64 is formed with an opening 65 for providing an access for adjustment jigs which will be described in greater detail in the following description. A lower part of the concave mirror support portion 60 is also provided with an opening 66 immediately below the concave mirror 36 for providing an access for adjustment jigs which will be described in greater detail in the following description. For the structures of the openings 65 and 66, reference should be also made to FIG. 15.

The bonding agent that are used in bonding various components together such as the bonding between the wavelength converting device holder 581 and the base 38 preferably consists of a UV curing bonding agent.

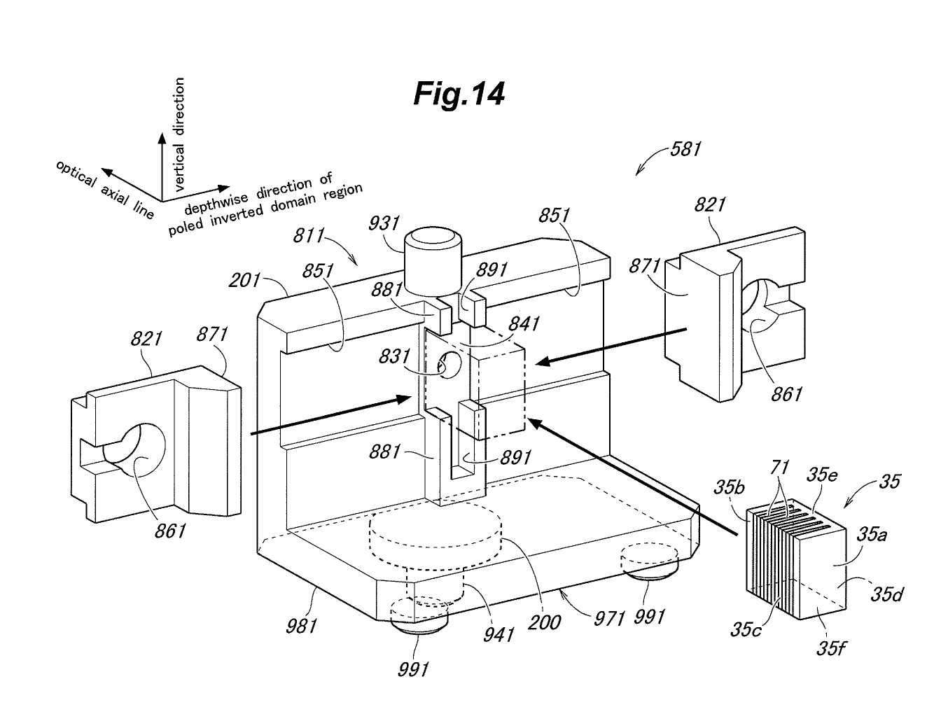

FIG. 14 is an exploded perspective view of the wavelength converting device holder 581, and FIG. 15 is a partly exploded perspective view of the green laser light source unit 2.

As shown in FIG. 14, the wavelength converting device holder 581 consists of a holder main body 811 and a pair of clamping members 821 formed separately from the holder main body 811. The holder main body 811 is formed with an optical path hole 831 for conducting the laser beam from the wavelength converting device 35 to the concave mirror 36. The exit end of this optical path hole 831 expands progressively outward or is funnel shaped as shown in FIG. 13 also.

The incident surface 35a and exit surface 35b of the wavelength converting device 35 are formed as highly precise and highly parallel planes by precision grinding, but the side surfaces 35c and 35d, top surface 35e and bottom surface 35f are not finished with as high prevision as the incident surface 35a and exit surface 35b in terms of being perpendicular and parallel, and each individual wavelength converting device 35 is cut apart from the substrate with some manufacturing errors. Therefore, in order to properly position the wavelength converting device 35, the incident surface 35a finished with a high precision is brought into contact with a reference surface 84 through which the optical path hole 85 is passed.

The clamping members 821 engages the two side surfaces 35c and 35d opposing each other in the depthwise direction of the poled inverted domain regions 71 so as to clamp the wavelength converting device 35 from two lateral sides. The holder main body 811 is formed with a guide groove 851 for receiving the clamping members 821 for guiding the lateral movement of the clamping members 821 while restricting the vertical movement thereof. The clamping members 821 are fixedly attached to the holder main body 811 by using a bonding agent, and each clamping member 821 is formed with a hole 861 for receiving the bonding agent.

The holder main body 811 and the clamping members 821 are made of electro-conductive material such as metal, and the contact surface 871 of each clamping member 821 engaging the corresponding side surface 35c, 35d of the wavelength converting device 35 is coated with a conductive bonding agent. Thereby, the side surfaces 35c and 35d of the wavelength converting device 35 are electrically connected to each other, and are held at a same electric voltage so that the changes in the refractive index due to charge-up can be avoided.

The holder main body 811 is formed with a retaining portion 881 for vertically clamping the wavelength converting device 35, and a vertical groove 891 is formed in the retaining portion 881 for receiving a bonding agent. Thereby, the bonding agent is deposited on the top surface 35e and bottom surface 35f of the wavelength converting device 35 so that the wavelength converting device 35 may be fixedly attached to the holder main body 811.

As shown in FIG. 13, the base 38 is formed with a first reference surface 911 and 921 extending perpendicularly to the optical axial line and facing the concave mirror 36. More specifically, the first reference surface 911 and 921 includes an upper part 911 formed on a part of the bridge portion 64 connecting the laser medium support portion 561 and the concave mirror supporting portion 60, and a lower part 921 formed on the base 38.

The wavelength converting device holder 581 is provided with a pair of cylindrical stub shafts 931 and 941 extending vertically from upper and lower ends thereof in a coaxial relationship. See FIG. 14 also. The first reference surface 911 and 921 consists of a single surface perpendicular to the optical axial line, and the position of the wavelength converting device holder 581 along the optical axial line can be determined by the stub shafts 931 and 941 engaging the first reference surface 911 and 921.

The stub shafts 931 and 941 may be slid laterally along the first reference surface 911 and 921 so that the wavelength converting device holder 581 may be laterally adjusted (in the depthwise direction of the poled inverted domain regions 71) with respect to the base 38 without changing the position of the wavelength converting device holder 581 along the optical axial line. The stub shafts 931 and 941 may also be turned around the central axial line thereof while engaging the first reference surface 911 and 921 so that the wavelength converting device holder 581 may be angularly adjusted around an axial line (which is vertical in the illustrated embodiment) perpendicular to the optical axial line.

The wavelength converting device 35 is positioned by a mounting reference surface 841 of the wavelength converting device holder 581 from which the optical path hole 831 opens out, and this mounting reference surface 841 extends in parallel with the generating line (central axial line) of the cylindrical shape of the stub shafts 931 and 941. The laser medium 34 is positioned by contacting the incident surface 34a thereof with a mounting reference surface 951 from which the optical path hole 63 opens out. Therefore, by placing the central axial line of the stub shafts 931 and 941 in parallel with the mounting reference surface 841 for the wavelength converting device 35 with a required precision in the wavelength converting device holder 581, and placing the mounting reference surface 951 for the laser medium 34 in parallel with the first reference surface 911 and 921 with a required precision in the base 38, the incident surface 35a and exit surface 35b of the wavelength converting device 35 may be placed in parallel with the incident surface 34a and exit surface 34b of the laser medium 34 with a required precision.

The lower holder support portion 592 is formed with a second reference surface 961 defining a plane perpendicular to the first reference surface 911 and 921 and in parallel with the optical axial line and the depthwise direction of the poled inverted domain regions 71 of the wavelength converting device 35.

The wavelength converting device holder 581 is provided with a leg portion 971 extending from a lower part thereof in the shape of letter L and engaging the second reference surface 961. The leg portion 971 includes a plate portion 981 extending from a lower portion 201 of the wavelength converting device holder 581 defining the mounting reference surface 841 for the wavelength converting device 35, a stepped portion 200 formed on the lower surface of the base end part of the leg portion 971, and a pair of bosses 991 extending from the lower side of the free end of the leg portion 971 laterally spaced apart relationship. See FIG. 14. The plate portion 981 is therefore located under the wavelength converting device 35 and the laser medium 34 so that the space defined under the wavelength converting device 35 and the laser medium 34 can be effectively utilized, and this contributes to the compact design of the green laser light source unit 2. The lower stub shaft 941 may extend from the lower surface of the stepped portion 200.

The two bosses 991 are spaced apart from each other in the lateral direction (or in the depthwise direction of the poled inverted domain regions 71), and the stepped portion 200 is located laterally intermediate between the two bosses 991, and offset from the two bosses 991 in the direction of the optical axial line. The stepped portion 200 and the bosses 991 have a same height (or have lower ends located on a common horizontal plane). Thereby, the stub shafts 931 and 941 of the wavelength converting device holder 581 are prevented from tilting from the vertical axial line or the axial line perpendicular to the optical axial line and the depthwise direction of the poled inverted domain regions 71.

The leg portion 971 of the wavelength converting device holder 581 is resiliently urged against the second reference surface 961 by a sheet spring 202 which is bent into the shape of a rectangular letter C and clamps the leg portion 971 of the wavelength converting device holder 581 and the holder support portion 592 defining the second reference surface 961 toward each other. Thereby, the wavelength converting device holder 581 may be laterally displaced without tilting so that the positional adjustment work is facilitated. The resilient force of the spring 202 can be used for temporarily retaining the wavelength converting device holder 581 at the adjusted position, and the wavelength converting device holder 581 may be permanently attached to the lower holder support portion 592 by using a bonding agent once the positional adjustment is finalized.

As shown in FIG. 15, the lower part of the sheet spring 202 engaging the lower surface of the holder support portion 592 is formed with a pair of notches 204 for receiving projections 203 formed on the lower surface of the holder support portion 592 so that the sheet spring 202 is prevented from moving along the optical axial line or in the lateral direction with respect to the holder support portion 592. The upper part of the sheet spring 202 engaging the upper surface of the leg portion 971 of the wavelength converting device holder 581 is formed with a semi-spherical engagement portion 205 for allowing the leg portion 971 of the wavelength converting device holder 581 to be smoothly slid with respect to the upper part of the sheet spring 202 which is fixedly secured to the holder support portion 592.

In particular, an adjustment margin of a prescribed range (±0.4 degrees, for instance) is defined around each of the two peak points (θ=±0.6 degrees in this case) of the wavelength conversion efficiency η for the wavelength converting device 35, and the wavelength converting device holder 581 is supported by the base 38 such that the tilting angle θ of the wavelength converting device 35 can be adjusted within this adjustment margin.

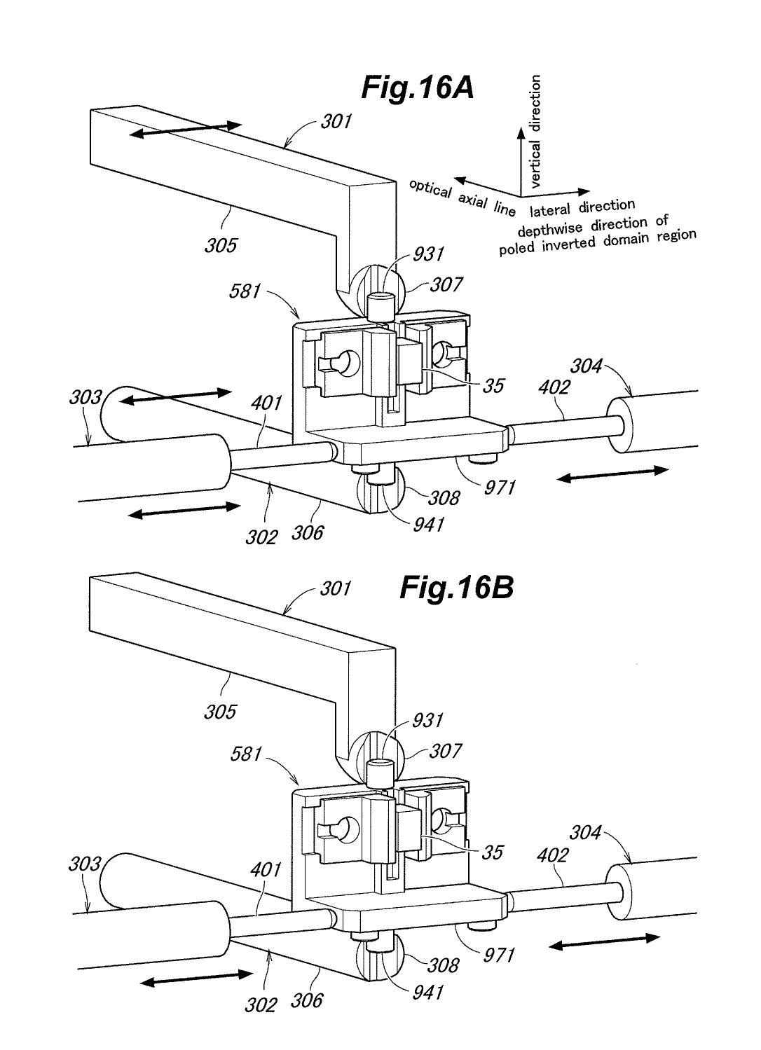

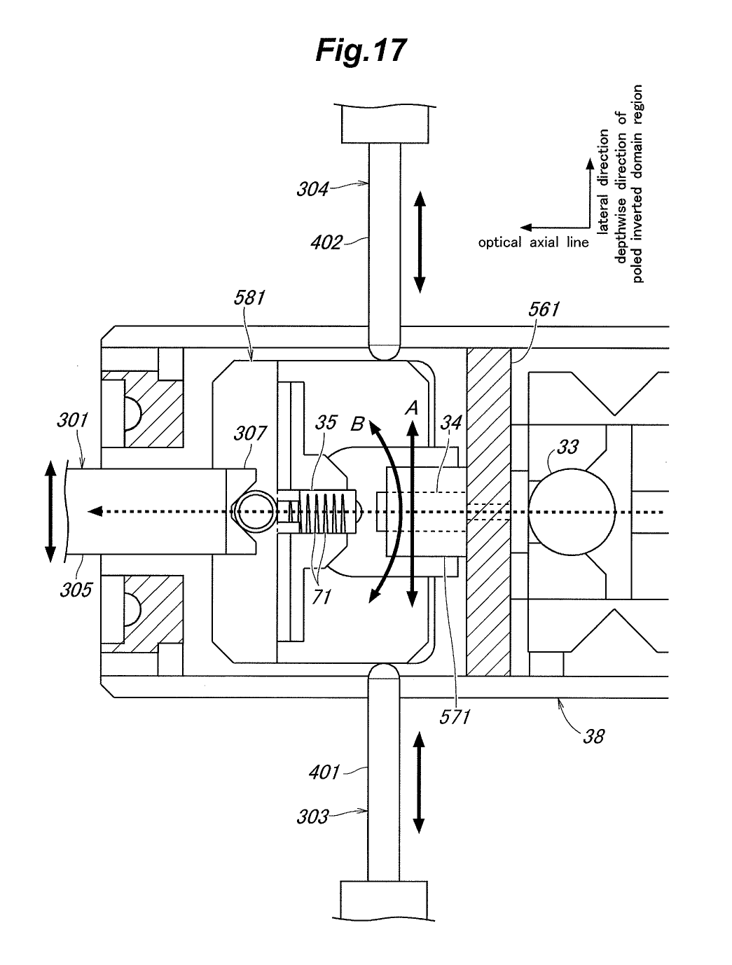

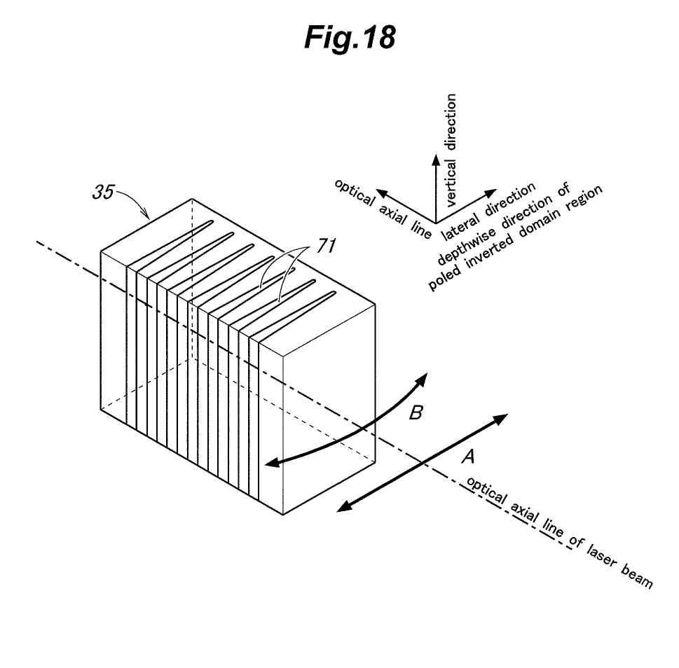

FIG. 16 is a perspective view showing the process of adjusting the position and angle of the wavelength converting device holder 581 by using adjustment jigs 301 to 304. FIG. 17 is a plan view showing the process of adjusting the position and angle of the wavelength converting device holder 581 by using the adjustment jigs 301 to 304. FIG. 18 is a perspective view showing the process of adjusting the position and angle of the wavelength converting device 35 with respect to the optical axial line of the laser beam.

As shown in FIGS. 16a, 16b and 17, the process of adjusting the position and angle of the wavelength converting device holder 581 is performed by using the first adjustment jigs 301 and 302 engaging the stub shafts 931 and 941 of the wavelength converting device holder 581 and the second adjustment jigs 303 and 304 engaging the leg portion 971 of the wavelength converting device holder 581.

The first adjustment jigs 301 and 302 are each provided with an arm 305, 306 extending in the direction of the optical axial line. The upper first adjustment jig 301 is passed into the opening 65 defined above the concave mirror 36, and the lower first adjustment jig 302 is passed into the opening 66 defined under the concave mirror 36, as shown in FIGS. 13 and 15, to press the stub shafts 931 and 941 from the side of the concave mirror 36 in the direction of the optical axial line against the first reference surface 911 and 921. The engaging surface 307, 308 of each arm 305, 306 that engages the corresponding stub shaft 931, 941 is given with a V-shaped cross section so that the stub shafts 931 and 941 may be laterally actuated while the stub shafts 931 and 941 is pressed against the first reference surface 911 and 92 and is permitted to turn around the central axial line thereof.

The second adjustment jigs 303 and 304 are each provided with a laterally extending arm 401, 402 so that the leg portion 971 of the wavelength converting device holder 581 can be pressed from the two lateral sides. The engagement portion of each arm 401, 402 engaging the leg portion 971 is given with a semi-spherical shape, and engages a part of the leg portion 971 offset from the central axial line of the stub shafts 931 and 941

When both the first and second adjustment jigs 301 to 304 are displaced laterally as shown in FIG. 16a, the wavelength converting device holder 581 is displaced laterally as indicated by arrow A in FIG. 17. As a result, the wavelength converting device 35 can be moved in the depthwise direction of the poled inverted domain regions 71 with respect to the optical axial line as indicated by arrow B in FIGS. 17 and 18.

When the second adjustment jigs 303 and 304 are displaced laterally while the first adjustment jigs 301 and 302 are held stationary as shown in FIG. 16b, the wavelength converting device holder 581 is tilted in the lateral direction with respect to the optical axial line as indicated by arrow B in FIGS. 17 and 18.

The process of adjusting the position and angle of the wavelength converting device 35 is described in the following. First of all, the positioning of the wavelength converting device 35 is adjusted in the lateral direction (or the in the depthwise direction of the poled inverted domain regions 71). This positional adjustment is performed while monitoring the laser output by using a power meter. In particular, the wavelength converting device holder 58 is moved laterally so as to maximize the laser output as indicated by arrow A in FIGS. 17 and 18.

The angular position of the wavelength converting device 35 is then adjusted so as to set the inclination angle θ of the wavelength converting device 35 with respect to the optical axial line is zero (see FIG. 8). This angular adjustment is performed while monitoring the beam shape of the laser beam such that the laser beam is given as a single beam by laterally tilting the wavelength converting device holder 581 as indicated by arrow B in FIGS. 17 and 18. Thereby, the inclination angle θ is set to zero.

Finally, the angle of the wavelength converting device holder 581 is adjusted so that the inclination angle θ of the wavelength converting device 35 with respect to the optical axial line changes within the adjustment margin that maximizes the wavelength conversion efficiency η (see FIG. 8). This angular adjustment is performed while monitoring the laser output by using a power meter. The wavelength converting device holder 581 is laterally tilted so as to maximize the laser output as indicated by arrow B in FIGS. 17 and 18. Thereby, the inclination angle θ of the wavelength converting device 35 is put within the prescribed range of high wavelength conversion efficiency and the interference caused by the overlapping of the laser beams B1 and B2 can be avoided as shown in FIG. 2.

The second reference surface 961 was located under the wavelength converting device holder 581 as shown in FIG. 13 in the foregoing embodiment, but the second reference surface 961 may also be located above the wavelength converting device holder 581. In such a case, the wavelength converting device holder 581 would be vertically inverted from that of the foregoing embodiment, and the leg portion would be located in an upper part of the wavelength converting device holder 581.

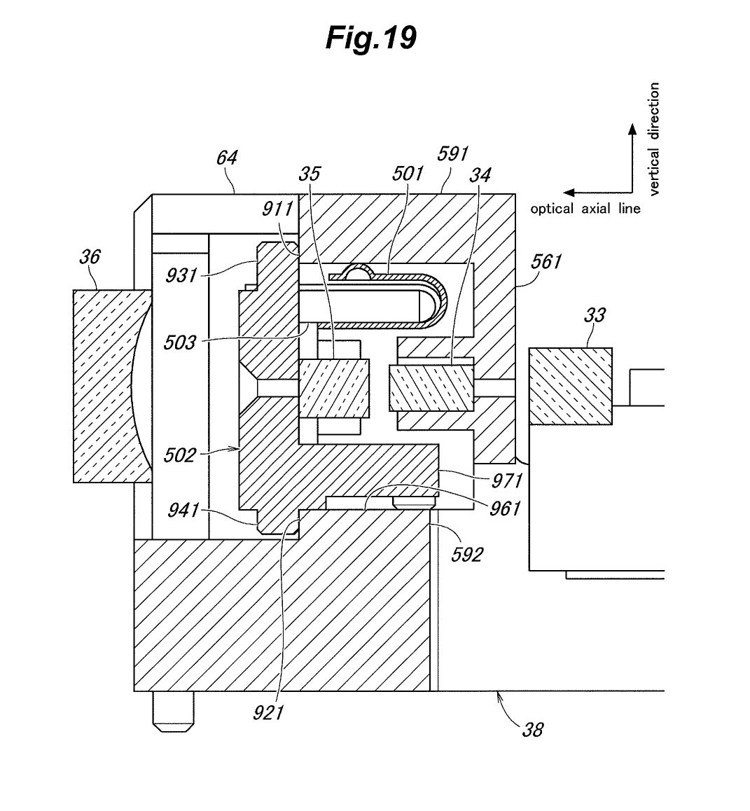

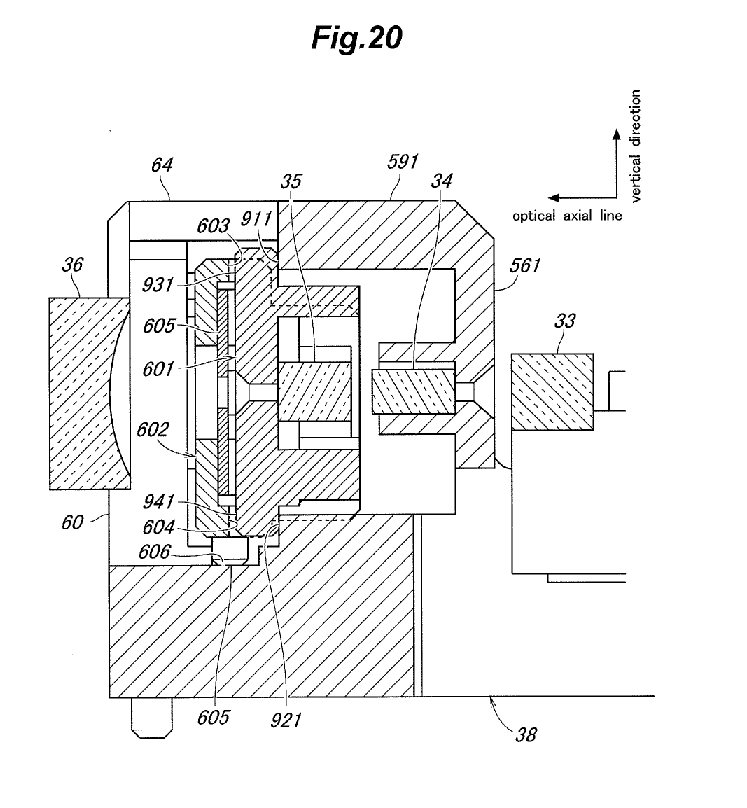

FIGS. 19 and 20 are cross sectional views showing modified embodiments of the wavelength converting device holder (holder). In the following description, the parts corresponding to those of the previous embodiment are denoted with like numerals without repeating the description of such parts.

The leg portion 971 of the wavelength converting device holder 581 and the lower holder support portion 592 provided with the second reference surface 961 were clamped by the sheet spring 202 to hold the leg portion 971 in contact with the second reference surface 961 in the embodiment shown in FIG. 13, but, in the embodiment illustrated in FIG. 19, the upper holder support portion 591 is used for supporting the spring force of the spring 501 to downwardly urge the wavelength converting device holder 502 and thereby press the leg portion 971 against the second reference surface 961. The spring 501 is mounted on a spring mounting portion 503 provided on a side (upper side) of the wavelength converting device holder 502 facing away from the leg portion 971 so that the spring 501 is deflected and resiliently pressed upon the upper holder support portion 591 by mounting the wavelength converting device holder 502 on the base 38.

The second reference surface 961 is located under the wavelength converting device holder 502 in this embodiment similarly as the embodiment illustrated in FIG. 13, but it is also possible to place the second reference surface above the wavelength converting device holder. In such a case, the wavelength converting device holder would be inverted such that the leg portion is located in an upper part thereof while the spring is placed on a lower part thereof.

The tilting of the stub shafts 931 and 941 was restricted by bringing the leg portion 971 of the wavelength converting device holder 581 into contact with the second reference surface 961 in the embodiment illustrated in FIG. 13, but a guide member 602 for supporting the stub shafts 931 and 941 of the wavelength converting device holder 601 is used for restricting the tilting of the stub shafts 931 and 941 in the embodiment illustrated in FIG. 20.

The guide member 602 is provided with a pair of recesses 603 and 604 for retaining the stub shafts 931 and 941 of the wavelength converting device holder 601 in a moveable manner in the direction of the optical axial line, and a sheet spring 605 is interposed between the wavelength converting device holder 601 and the guide member 602 to urge these parts away from each other. Thereby, the stub shafts 931 and 941 of the wavelength converting device holder 601 are held in contact with the first reference surface 911 and 921. The guide member 602 performs the function of supporting the reaction force of the spring 605 by having the rear surface thereof abutting the concave mirror support portion 60 of the base 38.

The base 38 is formed with the second reference surface 606 defining a plane perpendicular to the first reference surface 911 and 921 similarly as the embodiment illustrated in FIG. 13. As a leg portion 605 provided in a lower part of the guide member 602 engages the second reference 606, the guide member 602 is prevented from tilting.

In this case, the first adjustment jigs 301 and 302 for retaining the stub shafts 931 and 941 in contact with the first reference surface 911 and 921 are not necessary. See FIG. 17. The second adjustment jigs 303 and 304 may be used for turning the wavelength converting device holder 601, but an adjustment member may be provided on the guide member 602 to enable the angle of the wavelength converting device holder 601 to be adjusted. For instance, a screw may be laterally threaded into the guide member 602, and press the wavelength converting device holder 601 with the tip of this screw so that the angle of the wavelength converting device holder 601 may be adjusted by turning the screw.

The mounting reference surface 841 for positioning the wavelength converting device 35 consisted of a single plane, and the exit surface 35b of the wavelength converting device 35 was configured to contact the mounting reference surface 841 over the entire surface thereof in the embodiment illustrated in FIG. 14. However, it is also possible to provide three projections having a same height around the optical path hole 831, in place of the mounting reference surface 841, for positioning the wavelength converting device 35 by using the top surfaces of the projections as a reference surface. In such a case, the wavelength converting device 35 is supported by three points.

When the reference surface 87 consists of a single surface for positioning the wavelength converting device 35 as in the embodiment illustrated in FIG. 14, owing to the inevitable limit in the precision of the planarity of the reference surface, some play in the mounting structure is inevitable, and this causes some uncertainty in the angular position of the wavelength converting device 35. The angular change caused by the play in the mounting structure for the wavelength converting device 35 is highly unpredictable, and this may cause some fluctuations in the angular position of the wavelength converting device 35. The bonding agent for mounting the wavelength converting device 35 shrinks during the course of curing, and this occurs to varying degrees depending on each particular situation. This also contributes to the amplification of the variations in the angular position of the wavelength converting device 35.

On the other hand, when the wavelength converting device 35 is supported by three projections at three points, the play in the mounting structure for the wavelength converting device 35 may be eliminated, and the wavelength converting device 35 may be supported in a more stable manner. Also, the fluctuations in the angular position of the wavelength converting device 35 can be reduced because the angular position of the wavelength converting device 35 are much less affected by the causes of the fluctuations such as the existence of dents in the reference surface or inclusion of foreign matters. Thereby, the angular adjustment margin for the wavelength converting device 35 can be reduced, and the yield of the manufacturing process can be improved. Also, the work involved in the angular adjustment of the wavelength converting device 35 can be simplified.

### Third Embodiment

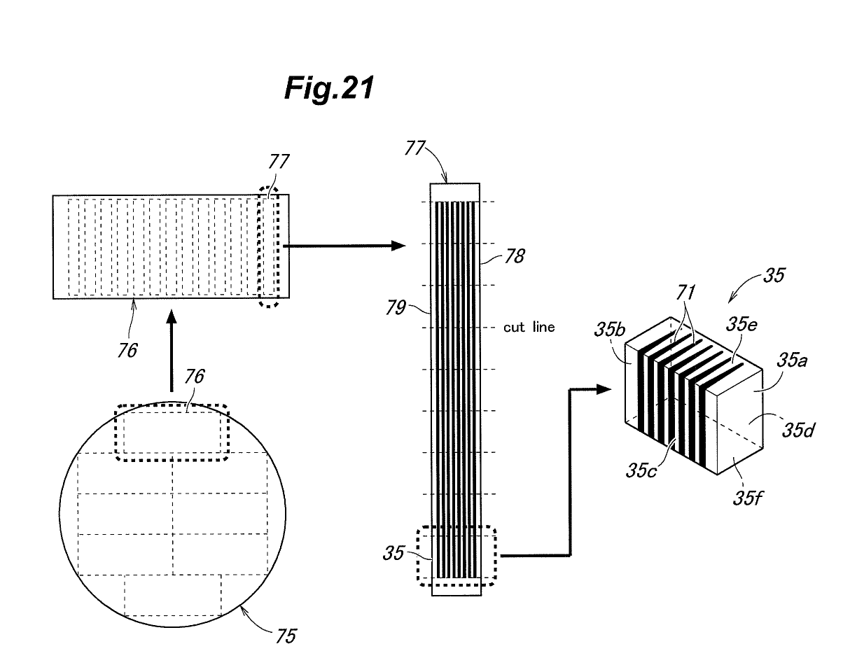

A third embodiment of the present invention is described in the following with reference to FIGS. 21 to 23. The third embodiment uses a wavelength converting device 35 similar to those used in the first and second embodiments.

FIG. 21 is a schematic diagram showing the process of fabricating the wavelength converting device 35. The wavelength converting device 35 shown in FIG. 4 is fabricated by the process illustrated in FIG. 21. First of all, an electrode film is formed on the surface of a wafer 75 consisting of a ferroelectric crystal, and an electrode pattern including the periodic electrodes and opposing electrodes is formed in the electrode film by photolithography and etching. A substrate 76 is cut out from the wafer 75, and is further cut into a plurality of elongated pieces called stacks 77. By applying a voltage to the electrodes of each stack 77 to cause periodic inversion of crystal domains, a periodic poled structure can be obtained. The end surfaces 78 and 79 corresponding to the incident surface 35a and exit surface 36b of the wavelength converting device 35 are optically ground and polished. A wavelength converting device 35 is cut out from each stack 77.

As the optical grinding process can be performed on the stack 77 having a relative large size, the stack 77 can be accurately positioned during the optical grinding process without any difficulty so that the incident surface 35a and exit surface 36b of the wavelength converting device 35 can be finished as highly planar and parallel surfaces.

In this wavelength converting device 35, only the incident surface 35a and exit surface 36b thereof are finished as highly planar and parallel surfaces while the top surface 35e and the bottom surface 35f may consist of rough surfaces produced when cutting out the wavelength converting device 35 from the stack 77, and the side surfaces 35c and 35d consist of the front and back surfaces of the wafer 75. Therefore, the side surfaces 35c and 35d, the top surface 35e and the bottom surface 35f may have some manufacturing errors, and may not be so planar or parallel as the incident surface 35a and exit surface 36b thereof.

In FIG. 4, the wavelength converting device 35 is shown as having the periodic electrodes 73 and opposing electrode 74 on the side surfaces 35c and 35d of the wavelength converting device 35 for the convenience of illustration, but are removed by grinding when the work piece is still in the state of the stack.

In the third embodiment, the wavelength converting device 35 is positioned in a similar way as in the second embodiment as illustrated in FIGS. 14 and 15, but the wavelength converting device 35 is fixedly secured as described in the following.

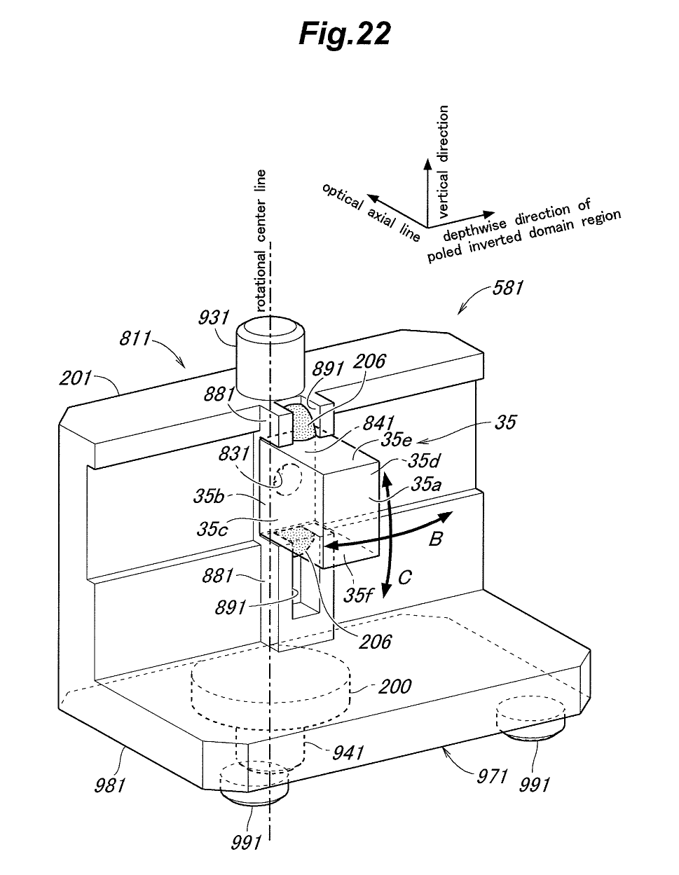

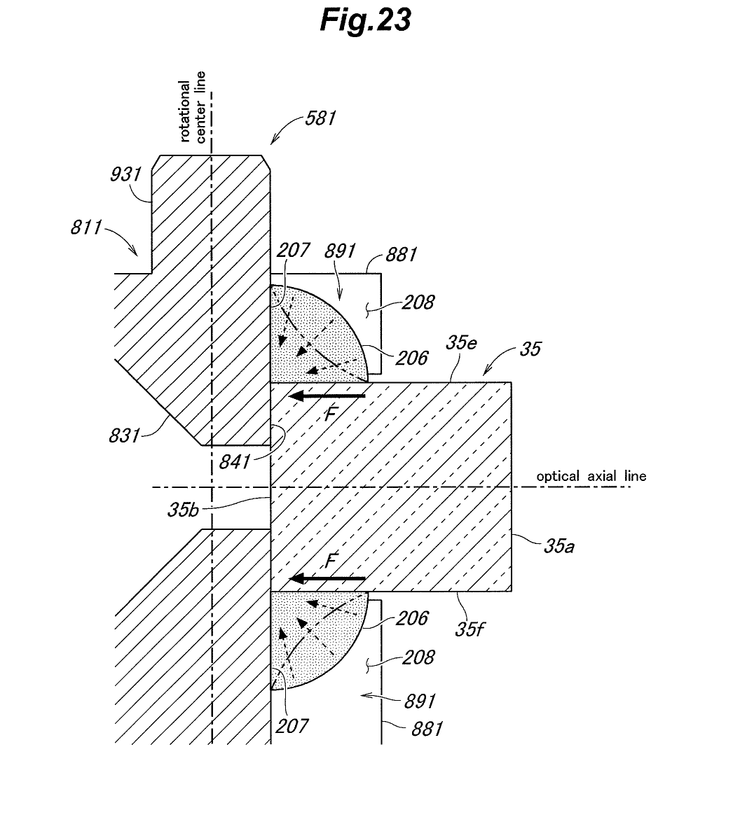

FIG. 22 is a perspective view showing a fixing structure for fixedly securing the wavelength converting device 35 to the wavelength converting device holder 581, and FIG. 23 is a cross sectional view schematically showing the mode of biasing the wavelength converting device 35 by using a bonding agent.

As shown in FIG. 22, the wavelength converting device 35 is fixedly attached to the wavelength converting device holder 581 by using a bonding agent 206 deposited in each of the recesses 891. Each recess 891 is open both toward the wavelength converting device 35 and toward the front or toward the incident surface 35a. The bonding agent 206 is placed in each recess 891, and allowed to cure while the exit surface 35b is brought into close contact with the mounting reference surface 84 by pressing the wavelength converting device 35 from the side of the incident surface 35a. As a result, the wavelength converting device 35 is fixedly secured to the wavelength converting device holder 581 via the bonding agent 206. The bonding agent 206 may be deposited in each recess 891 by using a suitable dispenser, and preferably consists of a UV curing type bonding agent.

As shown in FIG. 23, the bonding agent 206 is applied to the parts of the top surface and bottom surface 35f of the wavelength converting device 35 adjacent to the exit surface 35b. The bonding agent 206 is also applied to the bottom surface 207 of each recess 891 defined adjacent to and in parallel with the mounting reference surface 841 and the side surfaces 208 of each recess 891.

As the bonding agent 206 is deposited in the corner regions defined between the top surface 35e and bottom surface 35f of the wavelength converting device 35, and the bottom surface 207 extending substantially in parallel with the mounting reference surface 841, the contracting force of the bonding agent 206 produced in the course of the curing of the bonding agent 206 produces a biasing force F that urges the exit surface 35b of the wavelength converting device 35 against the mounting reference surface 841 at the parts of the top surface 35e and bottom surface 35f of the wavelength converting device 35 where the bonding agent 206 is deposited. As a result, the exit surface 35b of the wavelength converting device 35 is kept in close contact with the mounting reference surface 941, and the mounting precision of the wavelength converting device 35 can be ensured.

In particular, the bonding agent 206 is deposited on the top surface 35e and bottom surface 35f of the wavelength converting device 35 which face away from each other, the contracting forces of the bonding agent 206 applied to the top surface 35e and bottom surface 35f balance with each other, and this also contributes to the improvement in the mounting precision of the wavelength converting device 35.

Also, as the bonding agent 206 is applied to the top surface 35e and bottom surface 35f of the wavelength converting device 35 which are on opposite sides the rotational axial line, the cured bonding agent 206 is enabled to effective secure wavelength converting device 35 against the rotational movement thereof. As a result, the mounting angle of the wavelength converting device 35 in the direction indicated by arrow C in FIG. 22 can be ensured at a high precision.

As shown in FIG. 22, the exit surface 35b contacting the mounting reference number 841 has a rectangular shape, and the wavelength converting device 35 is disposed such that the long sides thereof extending in parallel with the central axial line (rotational center line) of the stub shafts 931 and 941. Therefore, the wavelength converting device 35 is effectively prevented from tilting around one of the short sides of the exit surface 35b. As a result, the mounting angle of the wavelength converting device 35 in the direction indicated by arrow C in FIG. 22 can be ensured at a high precision.

As the angular position of the wavelength converting device 35 in the direction indicated by arrow C in FIG. 22 or around the axial line in parallel with the mounting reference surface 841 and perpendicular to the rotational axial line can be ensured at a high precision, the need for the adjustment of the angular position of the wavelength converting device 35 around this axial line can be eliminated.

The tilting of the wavelength converting device 35 in the direction indicated by arrow B in FIG. 22 or around one of the long sides of the exit surface 35b cannot be entirely controlled, but by adjusting the angular position of the wavelength converting device holder 581 in the direction indicated by arrow B in FIG. 22, any error in the mounting angle of the wavelength converting device 35 with respect to the wavelength converting device holder 581 can be corrected by the angular adjustment of the wavelength converting device holder 581 without creating any problem.

As discussed above, a relatively large biasing force F can be obtained with the progress of the curing of the bonding agent 206, by arranging the bottom surface 207 of the recess 891 having the bonding agent 206 deposited thereon to be perpendicular to the top surface 35e and bottom surface 35f of the wavelength converting device 35 or in parallel with the mounting reference surface 841 as shown in FIG. 23. The present invention is not limited by the example where the bottom surface 207 of the recess 891 having the bonding agent 206 deposited thereon is located on the same plane as the mounting reference surface 841, but there may be a step between the bottom surface 207 and the mounting reference surface 841.

In this embodiment also, an adjustment margin of a prescribed range (±0.4 degrees, for instance) is defined around each of the two peak points (θ=±0.6 degrees in this case) of the wavelength conversion efficiency for the wavelength converting device 35, and the wavelength converting device holder 57 and the holder support portion 59 are configured such that the tilting angle θ of the wavelength converting device 35 can be adjusted within this adjustment margin.

The adjustment of the position and angle of the wavelength converting device holder 581 can be performed by using the adjustment jigs 301 to 304 illustrated in FIGS. 16 and 17, and the interference between the laser beams B1 and B2 due to the overlapping of the laser beams B1 and B2 can be avoided as illustrated in FIG. 2 by placing the inclination angle θ of the wavelength converting device 35 within the prescribed high efficiency range.

The wavelength converting device holder 581 supporting the wavelength converting device 35 was rotatably disposed on the base 38 in the foregoing embodiments as shown in FIG. 12, but the wavelength converting device holder 581 may also be fixedly attached to the base. In such a case, because the angular position of the wavelength converting device 35 cannot be changed, the manufacturing precision and mounting precision of the wavelength converting device 35 are required to be high, but the present invention is still effective in ensuring the mounting precision of the wavelength converting device 35.

The foregoing description was directed to embodiments where the wavelength converting device is used as the main optical element, but the present invention is not limited to the use of a wavelength converting device, and other optical elements such as solid-state lasers may also be used without departing from the spirit of the present invention.

In the laser light source apparatus of the present invention, the laser output can be maximized by adjusting the position and angle of the wavelength converting device with respect to the optical axial line of the laser beam. The present invention is highly suitable for use as a light source for image display systems.

The laser light source apparatus of the present invention has the advantage of allowing the wavelength converting device to be mounted at a high precision and simplifying the adjustment of the position and angle of the wavelength converting device, and is highly suitable for use as a light source for image display systems.

Although the present invention has been described in terms of preferred embodiments thereof, it is obvious to a person skilled in the art that various alterations and modifications are possible without departing from the scope of the present invention which is set forth in the appended claims.

The contents of the original Japanese patent applications on which the Paris Convention priority claim is made for the present application as well as the contents of the prior art references mentioned in this application are incorporated in this application by reference.

1. A laser light source apparatus for generating a half wavelength laser beam from a base wavelength laser beam, comprising:
a laser device for emitting a base wavelength laser beam;
an optical system for causing a resonation of the base wavelength laser beam;
a wavelength converting device including a plurality of periodically formed poled inverted domain regions, each poled inverted domain region being wedge shaped and progressively narrower in a depthwise direction thereof for converting at least part of the base wavelength laser beam into a half wavelength laser beam;
a holder for retaining the wavelength converting device on an optical path of the base wavelength laser beam in the optical system; and
a base provided with a support portion for supporting the holder;
the holder being supported by the support portion so as to be moveable in the depthwise direction of the poled inverted domain regions and tiltable with respect to the optical path.

2. The laser light source apparatus according to claim 1, wherein one of the holder and the support portion is provided with a spherical projection, and the other of the holder and the support portion is provided with a recess elongated in the depthwise direction of the poled inverted domain regions to receive the spherical projection.

3. The laser light source apparatus according to claim 2, wherein an optical path hole is formed in each of the spherical projection and the recess for conducting the laser beam.

4. The laser light source apparatus according to claim 2, wherein the holder and the support portion are urged against each other by a spring.

5. The laser light source apparatus according to claim 1, wherein the laser device comprises a semiconductor laser for generating an excitation laser beam, and a laser medium for generating the base wavelength laser beam by being excited by the excitation laser beam,
the semiconductor laser, the laser medium and the wavelength converting device being integrally supported by the base.

6. The laser light source apparatus according to claim 1, wherein the holder is supported by the support portion so as to be rotatable around an axial line substantially perpendicular to the optical axial line.

7. The laser light source apparatus according to claim 6, wherein the holder is rotatable around an axial line substantially perpendicular to both the optical axial line and the depthwise direction of the poled inverted domain regions.

8. The laser light source apparatus according to claim 7, wherein the base is provided with a first reference surface defining a plane perpendicular to the optical axial line, and the holder is provided with a shaft portion in rolling engagement with the first reference surface.

9. The laser light source apparatus according to claim 8, wherein the base is provided with a second reference surface defining a plane perpendicular to the first reference surface and in parallel with the optical axial line, and the holder is provided with a leg portion in sliding engagement with the second reference surface.

10. The laser light source apparatus according to claim 9, further comprising a spring for urging the leg portion against the second reference surface.

11. A laser light source apparatus for generating a half wavelength laser beam from a base wavelength laser beam, comprising:
a laser device for emitting a base wavelength laser beam;
an optical system for causing a resonation of the base wavelength laser beam;
a wavelength converting device for converting at least part of the base wavelength laser beam amplified by the resonation into a half wavelength laser beam;
a holder for retaining an optical element included in the wavelength converting device; and
a base provided with a support portion for supporting the holder;
wherein the optical element includes an incident surface and an exit surface, and the holder is provided with a mounting reference surface with which one of the incident surface and exit surface is brought into contact for positioning the optical element, and
wherein the optical element is fixedly attached to the holder by using a bonding agent applied to both a surface of the optical element adjacent to the one of the incident surface and exit surface and a surface of the holder adjacent to an parallel to the mounting reference surface.

12. The laser light source apparatus according to claim 11, wherein the optical element comprises a wavelength converting device including a plurality of periodically formed poled inverted domain regions, each poled inverted domain region being wedge shaped and progressively narrower in a depthwise direction thereof for converting at least part of the base wavelength laser beam into a half wavelength laser beam.

13. The laser light source apparatus according to claim 12, wherein the bonding agent is applied to each of a pair of opposite surfaces of the optical element adjacent to the one of the incident surface and exit surface, and a surface of the holder adjacent to and parallel to the mounting reference surface.

14. The laser light source apparatus according to claim 13, wherein the one of the incident surface and exit surface has an elongated rectangular shape, and the holder is rotatable around an axial line substantially perpendicular to both the optical axial line and the depthwise direction of the poled inverted domain regions, the optical element being placed against the mounting reference surface with one of long sides of the one of the incident surface and exit surface extending in parallel with the rotational axial line of the holder.

15. The laser light source apparatus according to claim 11, wherein the laser device comprises a semiconductor laser for generating an excitation laser beam, and a laser medium for generating the base wavelength laser beam by being excited by the excitation laser beam,
the semiconductor laser, the laser medium and the wavelength converting device being integrally supported by the base.
